(19) United States
(12) Patent Application Publication
(10) Pub. No.: US 2023/0228953 A1
(43) Pub. Date: Jul. 20, 2023

(54) Self-Aligned Fanout Waveguide Structure on Interposer with Linear Multicore Optical Fiber

(71) Applicant: POET Technologies, Inc., Allentown, PA (US)

(72) Inventors: Suresh Venkatesan, San Jose, CA (US); Jing Yang, Singapore (SG); Lucas Soldano, San Jose, CA (US)

(21) Appl. No.: 17/990,891

(22) Filed: Nov. 21, 2022

Related U.S. Application Data
(60) Provisional application No. 63/281,691, filed on Nov. 21, 2021.

(51) Int. Cl. G02B 6/42

(52) U.S. Cl. CPC G02B 6/4227; G02B 6/4206; G02B 6/4245

(57) ABSTRACT

An interposer PIC structure having a fanout waveguide structure is described for which the patterned planar waveguides of the fanout waveguide structure is formed from a same hard mask patterning step comprising a patterned area for a lateral alignment aid used to align the linearly configured cores of a multicore fiber with a terminal end of the fanout waveguide structure. Areas of the same patterned hard mask may optionally include one or more fiducials and one or more alignment pillars for aligning mounted devices onto the PIC structure. Interposer PIC assemblies are described comprising the interposer PIC structure, multicore fibers having linearly configured arrays of cores, and devices mounted or otherwise formed on the interposer PIC structure. Methods of forming the interposer PIC structures and assemblies are also disclosed. The linearly configured cores of a multicore fiber are aligned in interposer PIC assemblies with a fanout waveguide structure formed from the planar waveguide layer on an interposer PIC structure to facilitate optical signal transfer between the cores of the multicore fiber and planar waveguides formed on the interposer and subsequently to devices mounted on the interposer and coupled to the patterned planar waveguides on the interposer.

The present invention claims priority to US Provisional Patent Application Ser. No. 63/281,691 filed on Nov. 21, 2021, hereby incorporated by reference in its entirety.

The present invention is related to U.S. patent application Ser. No. 17/499,323, and U.S. patent application Ser. No. 17/499,337, filed on Oct. 12, 2021 entitled “Self-Aligned Structure and Method on Interposer-based PIC”, hereby incorporated by reference in their entirety. The present invention is also related to U.S. patent application Ser. No. 17/242,686 and U.S. patent application Ser. No. 17/242,701, filed on Apr. 28, 2021 entitled “Structure and Method for Testing of PIC with an Upturned Mirror”, hereby incorporated by reference in their entirety.

### FIELD OF THE INVENTION

The present invention relates to photonic integrated circuits and to the formation and method of use of alignment features that are formed on an interposer-based optical planar waveguide structure.

### BACKGROUND

Developments in methods of manufacturing of photonic integrated circuits (PICs) have enabled the fabrication and integration of electrical, optoelectrical, and optical devices on the same substrate. In some applications, pre-formed optoelectrical die are integrated within PICs to provide functionality that may not be easily obtainable with similar devices formed directly on or within the substrate. Semiconductor lasers that emit signals at specific optical wavelengths suited for optical communications, for example, are readily fabricated from gallium arsenide and indium phosphide materials. The fabrication of devices that emit at these telecommunications wavelengths is not practical or achievable using silicon or insulating substrates, and thus requires the integration of pre-formed lasers into PIC mounting structures. The integration of these optoelectrical die into PICs, however, requires precise placement, and subsequent alignment after placement, of optical and electrical features on the die with optical and electrical features on the mounting substrate. Optical output from an integrated edge-emitting laser die, for example, must align with optical planar waveguides or other optical devices on the substrate to enable effective integration of the laser with other devices in optoelectrical or optical circuits on the PIC substrate.

In addition to the placement and integration of optoelectrical devices onto interposer substrates, other forms of optical devices require methodologies of integration and positioning. Optical fibers, for example, are used to deliver optical signals to a PIC and to enable transport of optical signals from a PIC to other locations in an optical signal system or network. In recent years, optical fibers with multiple cores each having the capacity for transferring optical signals have been developed that can simultaneously provide multiple parallel communications with the mounting of a single fiber. The use of multicore fibers can therefore, result in significant reductions in required PIC surface area in comparison to the use of multiple single core fibers. Effective utilization of the benefits provided by multicore fibers, however, require innovative coupling schemes to align the multiple channels of the multicore fibers with corresponding input or output channels on the PIC to which the multicore fibers are interfaced.

Alignment features facilitate the alignment of optical components and can include, for example, reference structures that enable the vertical and lateral alignment of the optical axes of optical devices mounted or otherwise formed in a PIC and the optical axes of waveguides present in the PIC. Such alignment features provide improvements in the manufacturability of photonic integrated circuits (PICs).

Passive alignment coupling schemes for the mounting of multicore fibers and other mounted devices that do not require direct feedback during the alignment process are preferable over techniques and integration schemes that require potentially time-consuming active alignment steps. Integration strategies that can also minimize or reduce coupling losses are also preferable over coupling schemes that can lead to lossy interfaces between mounted fibers and devices in the PICs to which these fibers and other devices are mounted.

Thus, a need in the art exists for device structures and methods that allow for passive integration of optical fibers, including multicore optical fibers, and for optoelectrical devices such as semiconductor lasers and photodiodes that provide suitable referencing schemes to enable effective alignment of integrated optoelectrical die with waveguides and other features on the substrate during the fabrication of PICs.

### SUMMARY

Embodiments disclosed herein include structures and methods for the formation of interposer-based photonic integrated circuit structures with alignment features that enable and facilitate the alignment of the optical axes of components utilized in the circuits.

In embodiments described herein, an interposer-based PIC structure is disclosed that includes a fanout waveguide structure, wherein the spacing of the waveguides at a terminal end of the fanout waveguide structure is configured to align with the linearly arranged cores of a multicore optical fiber. The fanout waveguide structure, in these embodiments, is formed from a planar waveguide layer on an interposer base structure comprised of a substrate and an optional electrical interconnect layer.

In other embodiments described herein, an interposer-based PIC structure is disclosed that includes a fanout waveguide structure and integrated alignment features formed from the planar waveguide layer of the interposer, wherein the spacing of the waveguides at a terminal end of the fanout waveguide structure is configured to align with the linearly arranged cores of a multicore optical fiber, and the integrated alignment features on the interposer further provide alignment of the fanout waveguide structure with optical and optoelectrical devices and components in the PIC with the linearly configured cores of the multicore fiber. The fanout waveguide structure and the integrated alignment features, in these embodiments, are formed from the planar waveguide layer on the interposer base structure.

In yet other embodiments described herein, an interposer-based PIC assembly is disclosed that includes a PIC structure and mounted optical devices, wherein the PIC structure includes a fanout waveguide structure, alignment pillars, fiducials, and lateral alignment aids for the alignment of a multicore fiber, and wherein the optical devices are mounted on the alignment pillars of the PIC. The spacing of the waveguides at a terminal end of the fanout waveguide structure is configured to align with the linearly arranged cores of a multicore optical fiber, and the integrated alignment features further provide alignment of the fanout waveguide structure with optical and optoelectrical devices and components on the PIC, including mounted devices such as lasers and photodetectors, for example, and including multicore fibers.

In yet other embodiments described herein, an interposer-based PIC assembly is disclosed that includes a PIC structure and mounted optical devices, and that further includes a multicore optical fiber, the linearly arranged cores of which are fitted to the waveguides of the fanout waveguide structure or to optional spot size converters positioned between the fanout waveguide structure and the cores of the mounted optical multicore fiber. The PIC structure includes a fanout waveguide structure and integrated alignment features that include alignment pillars, fiducials, and lateral alignment aids for a multicore fiber. Optical devices are mounted on the alignment pillars formed on the PIC. The spacing of the waveguides at a terminal end of the fanout waveguide structure is configured to align with the linearly arranged cores of the mounted multicore optical fiber, and the integrated alignment features further provide alignment of the fanout waveguide structure with optical and optoelectrical devices and components in the PIC, including mounted devices such as lasers and photodetectors.

In yet other embodiments, an interposer-based PIC is disclosed that includes multiple layers of a fanout waveguide structure, with a dielectric spacing layer between the multiple layers. And in yet other embodiments, an interposer-based PIC is disclosed that includes multiple layers of a fanout waveguide structure, wherein each layer of the fanout waveguide structure is separated by a dielectric layer, and that further includes integrated alignment features formed in each of the planar waveguide layers from which each of the fanout waveguide structures are formed, wherein the integrated alignment features include alignment pillars, one or more fiducials, and lateral alignment aids that facilitate alignment of one or more multicore fibers. And in yet other embodiments, an interposer-based PIC assembly is disclosed that includes a PIC structure with multiple layers of a fanout waveguide structure formed on an interposer and mounted optical or optoelectrical devices, wherein each layer of the fanout waveguide structure is separated by a dielectric layer and wherein each of the planar waveguide layers from which each of the fanout waveguide structures are formed includes integrated alignment features, and wherein the mounted optical or optoelectrical devices are mounted on alignment pillars formed from one or more of the planar waveguide layers. And in yet other embodiments, an interposer-based PIC assembly is disclosed that includes a PIC structure that includes multiple layers of a fanout waveguide structure, mounted optical or optoelectrical devices on the PIC structure, and one or more multicore optical fibers, wherein each layer of the fanout waveguide structure is separated by a dielectric layer and wherein each of the planar waveguide layers from which each of the fanout waveguide structures are formed includes integrated alignment features, and wherein mounted optical or optoelectrical devices are mounted on alignment pillars formed from one or more of the planar waveguide layers, and wherein the optical axes of the mounted optical or optoelectrical devices are aligned with the optical axes of the waveguides of the fanout waveguide structure and the optical axes of the fanout waveguide structure are aligned with the optical axes of the cores of the one or more linearly configured portions of the one or more multicore optical fibers.

Other aspects and features of embodiments will become apparent to those skilled in the art upon review of the following detailed description in conjunction with the accompanying figures.

### BRIEF DESCRIPTION OF THE DRAWINGS

FIG. 1A shows an embodiment of an interposer PIC structure having a fanout waveguide and self-aligned alignment features for placement, mounting, and alignment of devices and multicore fibers.

FIG. 1B shows an embodiment of an assembly comprised of an interposer PIC structure having a fanout waveguide and cavity-mounted devices.

FIG. 1C shows an embodiment of an assembly comprised of an interposer PIC structure having a fanout waveguide, cavity-mounted devices, and a multicore fiber.

FIG. 1D shows an embodiment of an assembly comprised of an interposer PIC structure having a fanout waveguide, cavity-mounted devices, a multicore fiber, and mounted or otherwise formed devices integrated into the fanout waveguide structure.

FIG. 1E shows enlarged cross sectional schematic drawings of a multicore fiber in alignment with a fanout waveguide structure: (a) end view, and (b) cross section view.

FIGS. 2A-2D show embodiments of single planar waveguide layers of various fanout waveguide configurations for an interposer PIC structure in alignment with the multiple cores of various configurations of linearly configured cores of multicore fibers: FIG. 2A: 2 cores, FIG. 2B: 3 cores, FIG. 2C: 4 cores, and FIG. 2D: 5 cores.

FIGS. 3A-3F shows single planar waveguide layers of various fanout waveguide configurations for embodiments of interposer PIC structures in alignment with a portion of a multitude of cores having a linear configuration within the multitude of cores in the multicore fiber: FIG. 3A: 2 cores of a 3-core fiber, FIG. 3B: 3 cores of a 7-core fiber, FIG. 3C: 3 cores of a 13-core fiber, and FIG. 3D: 4 cores of a 13-core fiber, FIG. 3E: 4 cores of a 19-core fiber, and FIG. 3F: 5 cores of a 19-core fiber.

FIG. 4 shows an embodiment of a method of formation of a self-aligned assembly comprised of an interposer PIC structure having a fanout waveguide, one or more mounted devices, and one or more multicore fibers.

FIGS. 5A-5F show a sequence of perspective drawings that illustrate steps in a method of formation of an interposer structure used in embodiments of an interposer PIC structure.

FIG. 6A shows various electrical interconnect configurations used in embodiments of an interposer PIC structure.

FIG. 6B shows various thermally conductive layer configurations used in embodiments of an interposer PIC structure.

FIG. 7 shows an embodiment of a method of formation of STEP 410-2 of the embodiment of Method 410 shown in FIG. 4

FIGS. 8A-8G show a sequence of perspective drawings for an embodiment of a method of formation of an interposer PIC structure that includes a fanout waveguide, and for which the fanout waveguide is formed in alignment with fiducials, lateral alignment aids for the alignment of multicore fibers, and alignment pillars for vertical and lateral alignment of mounted devices.

FIG. 9 shows an embodiment of a method of formation of STEP 410-3 of the embodiment of Method 410 shown in FIG. 4

FIG. 10A shows a sequence of perspective drawings for the formation of a v-groove in an embodiment of a method of formation of an interposer PIC structure.

FIG. 10B shows a perspective drawing of an optical die having complementary alignment features to those of the interposer alignment pillars.

FIG. 10C shows a sequence of perspective drawings for the placement and subsequent alignment of cavity mounted devices in an embodiment of a method of formation of an interposer PIC assembly.

FIG. 11 shows a perspective drawing of an embodiment of a singulated PIC assembly comprised of an interposer PIC structure having a fanout waveguide and cavity-mounted devices and shown with a view of an unsingulated substrate having a multitude of PIC structures to illustrate wafer level processing.

FIG. 12A shows a perspective drawing of an embodiment of a singulated interposer PIC assembly of FIG. 11 that further includes a mounted multicore fiber. The singulated PIC assembly is shown on a packaging substrate. FIG. 12B shows another perspective drawing of a singulated PIC assembly mounted on a substrate. FIG. 12C shows a cross section of a singulated PIC with a multicore fiber in a package having a substrate and a lid.

FIG. 13A shows an embodiment of an interposer PIC structure having multiple planar waveguide layers, each having one or more fanout waveguides, and that includes self-alignment features for the placement, mounting, and alignment of devices and multicore fibers in each layer.

FIG. 13B shows an embodiment of an interposer PIC assembly comprised of an interposer PIC structure having multiple planar waveguide layers, each having a fanout waveguide, cavity-mounted devices, and a multicore fiber.

FIG. 13C shows enlarged cross sectional schematic drawings of an embodiment of a portion of an interposer PIC assembly having a multicore fiber with multiple linearly configured arrays of cores, each in alignment with a fanout waveguide structure: (a) end view, and (b) side view.

FIGS. 14A-14D show embodiments of PIC structures having multiple planar waveguide layers for various fanout waveguide configurations in alignment with multiple portions of linearly configured cores of a multicore fiber: FIG. 14A: 3 core fiber having a single core in alignment with an upper waveguide and two cores in alignment with a lower fanout waveguide, FIG. 14B: 7 core fiber having two cores in alignment with an upper fanout waveguide and three cores in alignment with the a lower fanout waveguide, FIG. 14C: 13 core fiber having four cores in alignment with an upper fanout waveguide and four cores in alignment with a lower fanout waveguide, and FIG. 14D: 19 core fiber having four cores in alignment with an upper fanout waveguide layer and four cores in alignment with a lower fanout waveguide layer.

FIGS. 15A-15C show an embodiment of an interposer PIC structure having two planar waveguide layers, having a fanout waveguide in each of the two planar waveguide layers, and having self-aligned lateral alignment features for alignment of a multicore fiber with each of the fanout waveguides.

FIGS. 16A-16C show an embodiment of an interposer PIC assembly comprised of surface-mounted and cavity-mounted devices, a multicore fiber, and an interposer PIC structure having two planar waveguide layers, having a fanout waveguide in each of the two planar waveguide layers, and having a self-alignment feature for alignment of a single multicore fiber having multiple arrays of linearly configured cores.

FIGS. 17A-17C show multicore mounting structures in embodiments of interposer PIC assemblies having FIG. 17A: a trench, FIG. 17B: a v-groove, and FIG. 17C: a fiber attach unit mounted to a fiber attach unit mounting site.

FIGS. 18A-18H show embodiments of interposer PIC assemblies with multicore fibers having radial alignment features formed on the fiber in configurations that enable passive alignment of the cores of the multicore fiber with the waveguides in an embodiment of a fanout waveguide.

FIGS. 19A-19D show embodiments of interposer PIC assemblies with multicore fibers having multiple radial alignment features in configurations that enable passive alignment of the cores of the multicore fiber with the waveguides in an embodiment of a fanout waveguide.

FIGS. 20A-20C show embodiments of interposer PIC assemblies with multicore fibers in configurations having one or more radial alignment features formed on a collar and sleeve that in combination with a multicore fiber enable passive alignment of the cores of the multicore fiber with the waveguides in an embodiment of a fanout waveguide.

FIGS. 21A-21F show embodiments of interposer PIC assemblies configured for methods of active alignment of the multiple cores of a multicore fiber with the waveguides in an embodiment of a fanout waveguide: FIG. 21A: trench before alignment, FIG. 21B: trench after alignment, FIG. 21C: v-groove before alignment, FIG. 21D: v-groove after alignment, FIG. 21E: fiber attachment unit before alignment, and FIG. 21F: fiber attachment unit after alignment.

FIG. 22A-22C show embodiments of interposer PIC assemblies configured for methods of active alignment of the multiple cores of a multicore fiber with the waveguides in an embodiment of a fanout waveguide in which the capture area of the waveguides or spot size converters is enlarged to facilitate improved optical coupling.

FIG. 23A-23D show embodiments of interposer PIC assemblies configured for methods of active alignment of the multiple cores of a multicore fiber with the waveguides in an embodiment of a fanout waveguide for which an extra channel is provided and used to facilitate alignment: FIG. 23A, FIG. 23B an extra channel is associated with one or more of the cores of the fiber and one or more corresponding waveguides on the interposer, and FIG. 23C, FIG. 23D extra channel is associated with one or more of the cores of the fiber that is not coupled to one or more corresponding waveguides on the interposer FIG. 23A and FIG. 23C are before alignment; FIG. 23C and FIG. 23D are after alignment.

FIGS. 24A-24D show embodiments of interposer PIC assemblies for methods of active alignment of the multiple cores of a multicore fiber with the waveguides in an embodiment of a fanout waveguide. An extra channel is provided and used to facilitate alignment and this extra channel is associated with one or more of the cores of the fiber that is not coupled to one or more corresponding waveguides on the interposer but rather to a waveguide that is firstly coupled to a reflector and secondly coupled to a measurement apparatus or emitting device.

### DETAILED DESCRIPTION OF EMBODIMENTS

### Introduction

Embodiments disclosed herein include PIC structures having a fanout waveguide formed from a planar waveguide layer on an interposer and also include interposer PIC assemblies comprised of at least a fanout waveguide structure and a multicore fiber for which the cores of the fiber are configured to be in alignment with the waveguides of the fanout waveguide structure. The fanout waveguide structure, in embodiments, is formed from a planar waveguide layer of an interposer base structure comprised of a substrate and an optional electrical interconnect layer. Also formed from the planar waveguide layer using a same hard mask patterning process, in some embodiments, are alignment pillars for mounting and alignment of optical and optoelectrical devices onto the interposer-based PIC, lateral alignment aids that facilitate alignment of the multicore fibers containing the linearly arranged cores, and fiducials that facilitate placement of devices onto the PIC. Methods of formation of these structures and assemblies are also disclosed herein that include the use of a hard mask patterning step in the formation of self-aligned waveguide structures and alignment aids that facilitate the alignment of the fanout waveguides with devices and fibers mounted onto the interposer structures.

In embodiments described herein, an interposer-based PIC structure is disclosed that includes a fanout waveguide structure, wherein the spacing of the waveguides at a terminal end of the fanout waveguide structure is configured to align with the linearly arranged cores of a multicore optical fiber.

In other embodiments described herein, an interposer-based PIC structure is disclosed that includes a fanout waveguide structure and integrated alignment features on the interposer, wherein the spacing of the waveguides at a terminal end of the fanout waveguide structure is configured to align with the linearly arranged cores of a multicore optical fiber, and the integrated alignment features on the interposer further provide alignment of the fanout waveguide structure with optical and optoelectrical devices and components in the PIC with the linearly configured cores of the multicore fiber. The fanout waveguide structure and the integrated alignment features, in these embodiments, are formed from the planar waveguide layer on an interposer base structure. The integrated alignment features that are formed from the planar waveguide layer of the interposer, in addition to the fanout waveguide structure, are alignment pillars for the mounting and alignment of optoelectrical devices onto the interposer-based PIC, and lateral alignment aids that facilitate the alignment of multicore fibers containing the linearly arranged cores with the waveguides of the fanout waveguide structure. One or more fiducials are also formed from the planar waveguide layer and hard mask to facilitate accurate placement, for example, of the optoelectrical devices onto the PIC substrate. The formation of the fanout waveguide structure, the alignment pillars, the fiducials, and the lateral alignment features for the multicore fiber, from a same planar waveguide layer using a common mask layer, enable accurate alignment resolution between these features, and which thusly enables the formation of PICs with low optical signal transfer losses between optical components in the PIC.

In yet other embodiments described herein, an interposer-based PIC assembly is disclosed that includes a PIC structure and mounted optical devices, wherein the PIC structure includes a fanout waveguide structure, alignment pillars, fiducials, and lateral alignment aids for the alignment of a multicore fiber, and wherein the optical devices are mounted on the alignment pillars of the PIC. The spacing of the waveguides at a terminal end of the fanout waveguide structure is configured to align with the linearly arranged cores of a multicore optical fiber, and the integrated alignment features further provide alignment of the fanout waveguide structure with optical and optoelectrical devices and components on the PIC, including mounted devices such as lasers and photodetectors, for example, and including multicore fibers. One or more optical or optoelectrical devices are mounted on alignment pillars formed on the interposer, and the use of the alignment pillars facilitates the alignment of the optical axes of these devices with the optical axes of the waveguides of the fanout waveguide structure.

In yet other embodiments described herein, an interposer-based PIC assembly is disclosed that includes a PIC structure and mounted optical devices, and that further includes a multicore optical fiber, the linearly arranged cores of which are fitted to the waveguides of the fanout waveguide structure or to optional spot size converters positioned between the fanout waveguide structure and the cores of the mounted optical multicore fiber. The PIC structure includes a fanout waveguide structure and integrated alignment features that include alignment pillars, fiducials, and lateral alignment aids for a multicore fiber. Optical devices are mounted on the alignment pillars formed on the PIC. The spacing of the waveguides at a terminal end of the fanout waveguide structure is configured to align with the linearly arranged cores of the mounted multicore optical fiber, and the integrated alignment features further provide alignment of the fanout waveguide structure with optical and optoelectrical devices and components in the PIC, including mounted devices such as lasers and photodetectors. One or more optical or optoelectrical devices are mounted on alignment pillars formed on the interposer-based PIC, and the use of the alignment pillars facilitates the alignment of the optical axes of these devices with the optical axes of the waveguides of the fanout waveguide structure and the alignment of the optical axes of the waveguides in the fanout waveguide structure to the linearly configured cores of the mounted multicore fiber.

In yet other embodiments, an interposer-based PIC structure is disclosed that includes multiple layers of a fanout waveguide structure, with a dielectric spacing layer between the multiple layers. And in yet other embodiments, an interposer-based PIC structure is disclosed that includes multiple layers of a fanout waveguide structure, wherein each layer of the fanout waveguide structure is separated by a dielectric layer, and that further includes integrated alignment features formed in each of the planar waveguide layers from which each of the fanout waveguide structures are formed, wherein the integrated alignment features include alignment pillars, one or more fiducials, and lateral alignment aids that facilitate alignment of one or more multicore fibers. And in yet other embodiments, an interposer-based PIC assembly is disclosed that includes a PIC structure with multiple layers of a fanout waveguide structure formed on an interposer and mounted optical or optoelectrical devices, wherein each layer of the fanout waveguide structure is separated by a dielectric layer and wherein each of the planar waveguide layers from which each of the fanout waveguide structures are formed includes integrated alignment features, and wherein the mounted optical or optoelectrical devices are mounted on alignment pillars formed from one or more of the planar waveguide layers. And in yet other embodiments, an interposer-based PIC assembly is disclosed that includes a PIC structure that includes multiple layers of a fanout waveguide structure, mounted optical or optoelectrical devices on the PIC structure, and one or more multicore optical fibers, wherein each layer of the fanout waveguide structure is separated by a dielectric layer and wherein each of the planar waveguide layers from which each of the fanout waveguide structures are formed includes integrated alignment features, and wherein mounted optical or optoelectrical devices are mounted on alignment pillars formed from one or more of the planar waveguide layers, and wherein the optical axes of the mounted optical or optoelectrical devices are aligned with the optical axes of the waveguides of the fanout waveguide structure and the optical axes of the fanout waveguide structure are aligned with the optical axes of the cores of the one or more linearly configured portions of the one or more multicore optical fibers.

Various embodiments are described herein with reference to the accompanying drawings that are intended to convey the scope of the invention to those skilled in the art. Accordingly, features and components described in the examples of embodiments described herein may be combined with features and components of other embodiments. The present invention is not limited to the relative sizes and spacings illustrated in the accompanying figures. It should be understood that a “layer” as referenced herein may include a single material layer or a plurality of layers. For example, an “insulating layer” may include a single layer of a specific dielectric material such as silicon dioxide, or may include a plurality of layers such as one or more layers of silicon dioxide and one or more other layers such as silicon nitride, aluminum nitride, among others. The term “insulating layer” in this example, refers to the functional characteristic layer provided for the purpose of providing the insulation property, and is not limited as such to a single layer of a specific material. Similarly, an electrical interconnect layer, as used herein, refers to a composite layer that includes both the electrically conductive materials for transmitting electrical signals and the intermetal and other layers required to insulate the electrically conductive materials. An electrical interconnect layer, as described herein may therefore include a patterned layer of electrically conducting material such as copper or aluminum as well as the intermetal dielectric material such as silicon dioxide, and spacer layers above and below the electrically conductive materials, for example, among other layers. Additionally, references herein to a layer formed “on” a substrate or other layer may refer to the layer formed directly on the substrate or other layer or on an intervening layer or layers formed on the substrate or other layer. References to the term “optical” devices, as used herein, may refer to a purely optical device such as a waveguide that does not have an electrical feature and to an optoelectrical device that has both an optical feature and an electrical feature, unless specified otherwise. An optical device, as used herein, is a device such as a waveguide, an arrayed waveguide, a spot size converter, a lens, a grating, among others, and an optoelectrical device is a device such as a laser or a photodetector that includes an optical feature and an electrical feature. In embodiments described herein, the use of the term “optical device” may include both optical devices and optoelectrical devices particularly in the context of the alignment of optical features of optical die that pertains to devices with or without an electrical feature. Like numbers in drawings refer to like elements throughout, and the various layers and regions illustrated in the figures are illustrated schematically. Figures provided herein are not drawn to scale but rather are intended to include and convey the various features comprising the embodiments described.

### Fanout Waveguide Structures and Assemblies Having a Single Planar Waveguide Layer

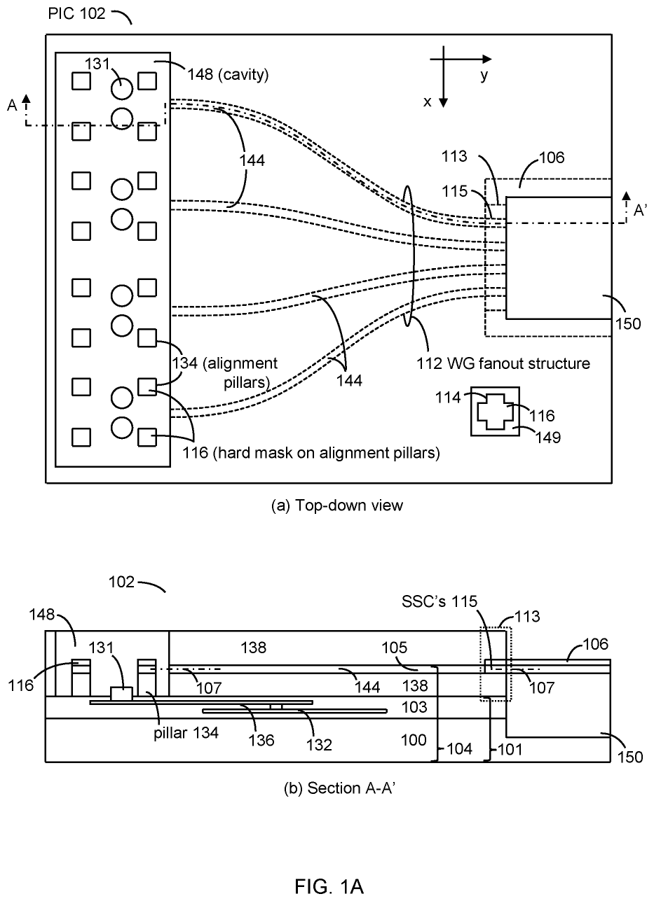

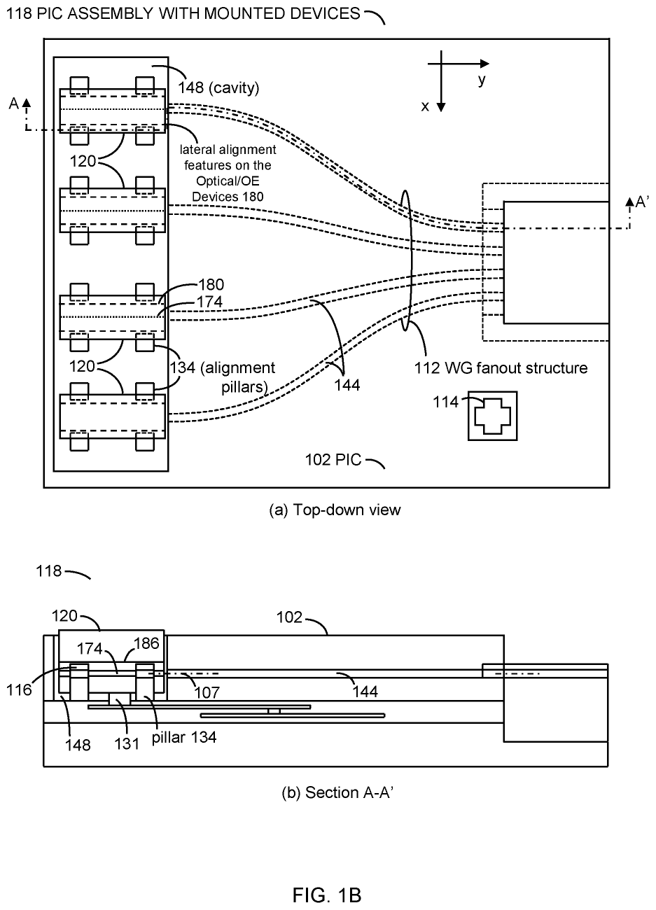

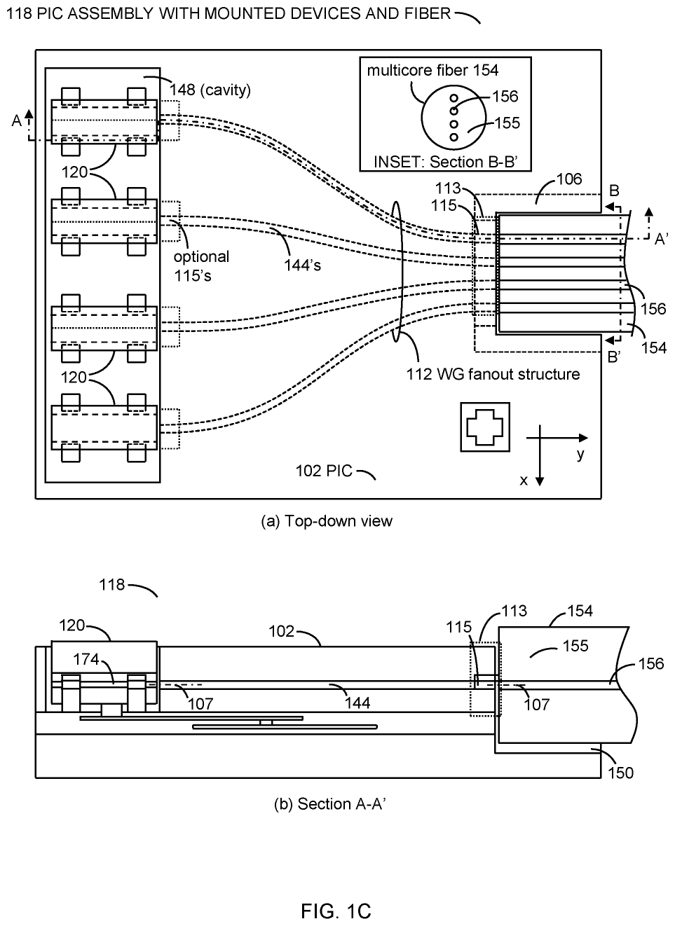

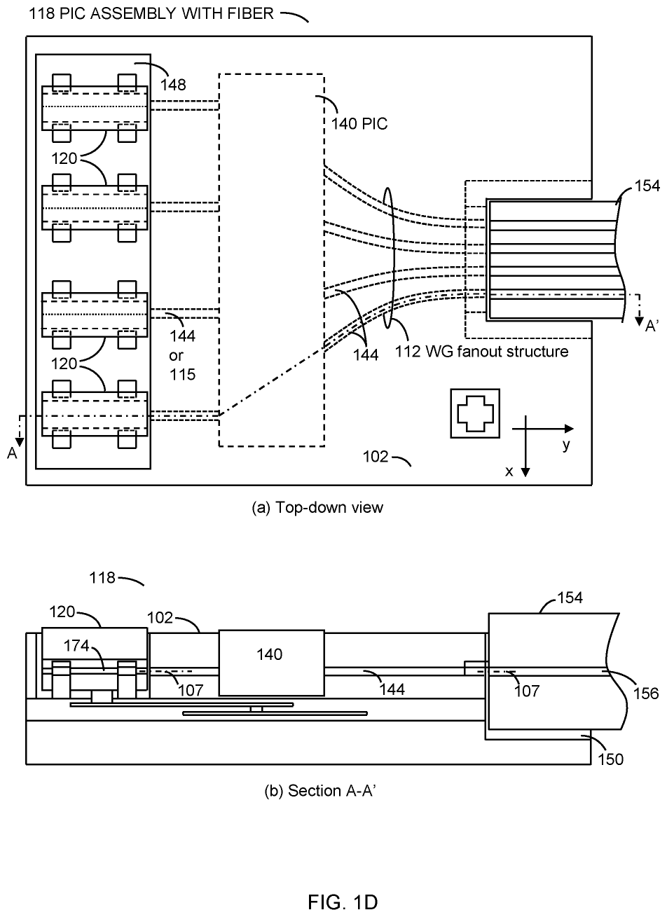

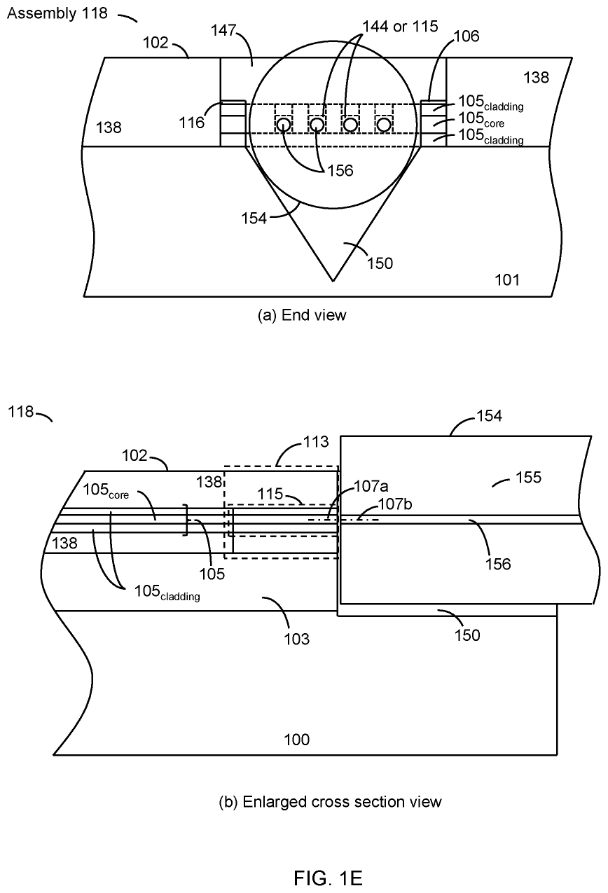

FIG. 1A shows schematic top-down and section views of an embodiment of an interposer-based PIC structure 102 that includes a fanout waveguide 112. In the embodiment of the PIC structure shown in the top-down view of FIG. 1A(a), the fanout waveguide 112 includes four patterned planar waveguides 144 formed from planar waveguide layer 105. Planar waveguide layer 105 is formed on interposer base structure 101 comprised of an electrical interconnect layer 103 and substrate 100 as shown in the cross section drawing in FIG. 1A(b). FIG. 1A(b) shows Section A-A′ from the top-down drawing of FIG. 1A(a). Each of the patterned planar waveguides 144 in the fanout waveguide structure 112 terminates in fanout waveguide manifold 113 through optional spot size converters 115. The manifold 113 comprising spot size converters 115 are shown in proximity to fiber mounting site 150. In embodiments, the fiber mounting site 150 may be a v-groove or a trench, for example, that enables the direct alignment and mounting of a multicore optical fiber or a relief that facilitates the mounting of a fiber attachment unit to which an optical fiber is firstly mounted as further described herein. Lateral alignment aid 106 is shown to partially border fiber mounting site 150 to facilitate lateral positioning of a fiber optic cable in the fiber mounting site 150.

Cavities 148, 149 are formed in all or a portion of the dielectric layers 138 and planar waveguide layer 105 as illustrated in FIGS. 1A(a) and 1A(b). Alignment pillars 134 are formed in the cavity 148 to facilitate mounting and alignment of optical devices in alignment with, for example, the patterned planar waveguides 144. Electrical contacts 131 are also shown in cavity 148 to enable electrical contact between mounted optoelectrical devices in the cavity to form a contact with electrical interconnects 132 in the electrical interconnect layer 103. Electrical interconnections in the layer 103 enable electrical connections between devices mounted in the cavity 148 and elsewhere on the interposer PIC 102. Alignment pillars 134 are formed, in an embodiment, using a patterning process selective to the dielectric layers 138 and planar waveguide layer 105 in comparison to patterned hard mask 116. Patterned hard mask layer 116 is a patterned layer with patterned areas that include the alignment pillars 134, fiducial marks 114, patterned planar waveguides 144, the lateral alignment aid 106, and in some embodiments, the spot size converters 115. Fiducials 114, formed using the patterned hard mask 116 are shown in recess 149. Use of a single hard mask patterning step to provide the patterned areas in the formation of these features, ensures alignment of these features within the lithographic and etch patterning resolution used. The use of a single hard mask is further described in detail herein.

FIG. 1A(b) further shows the interposer structure 104 comprised of the planar waveguide layer 105 on the interposer base structure 101 comprised of the electrical interconnect layer 103 and substrate 100. It should be noted that the vertical scale of Section A-A′ is enlarged for clarity for the film structures and the vertical scale for the fiber mounting site is compressed. Optional dielectric layer 138 may be a cladding layer, a spacer layer, a buffer layer, or other layer. Optical axis 107 is shown for the core of the planar waveguide 144. The electrical interconnect layer 103, is shown in the embodiment, comprised of electrically conductive layers 132 and intermetal dielectric layers 136. Electrically conductive layers 132 are formed from an electrically conductive material such as copper or aluminum, for example, to enable electrical interconnectivity between locations on the interposer PIC structure 102 and between devices mounted on the interposer PIC structure 102. Other metals and conductive materials may also be used to form all or a portion of the electrically conductive layers 132. Intermetal dielectric layer 136 is formed from electrically insulating material such as silicon dioxide, silicon nitride, silicon oxynitride, and fluorinated silicon oxides, among others. Thermally conductive insulating materials such as aluminum nitride and films formed from aluminum nitride may also be used to form all or a portion of the intermetal dielectric layers 136 to further facilitate the transmission of thermal energy on the interposer PIC structure 102.

FIG. 1B shows schematic top-down and section views of an embodiment of an interposer-based PIC assembly 118 comprised of mounted optical devices 120 and PIC structure 102. The top-down view is shown in FIG. 1B(a) and Section A-A′ from FIG. 1B(a) is shown in FIG. 1B(b). Mounted devices 120, shown in cavity 148 on alignment pillars 134, have optical feature 174 in alignment with the optical axis 107 of the patterned planar waveguides 144 of the fanout waveguide structure 112. In an embodiment, optical feature 174 may be, for example, a quantum well emitting layer of an emitting device such as an edge-emitting laser. In another embodiment, optical feature 174 may be a receiving facet of a photodetector. Other optical features may be present for other optical devices in other embodiments. Lateral alignment features 180 enable restricted movement of the optical devices 120 in the +/− x-direction as shown in the reference coordinate system in the embodiment. Lateral movement in the +y-direction is limited, in the embodiment, by the cavity wall. In other embodiments, alignment features may be shaped to form restricted movements in the lateral directions. (See U.S. patent application Ser. No. 17/499,337, entitled “Self-Aligned Structure and Method on Interposer-based PIC”.)

Vertical alignment of the optical axes, in the embodiment shown, is provided by the formation of one or more points of contact between the surface of the hard mask layer 116 of one or more alignment pillars 134 and the surface of the vertical alignment feature 186 of the cavity mountable device 120.

For lateral alignment, one or more points of contact of a vertical or near vertical feature of the optical device 120 can form one or more points of contact with one or more surfaces on the alignment pillars 134 that restrict or otherwise constrain the lateral movement of the mounted optoelectrical devices 120 in the x-direction. Additional embodiments and details of embodiments are provided herein.

After placement of one or more devices 120 onto the PIC structure 102, movement may occur, for example, during an alignment step in which the PIC structure is elevated in temperature such that one or more solder contacts 131 on the PIC structure or on the optical device 120 is raised near or above the melting temperature of the one or more contacts, and a force is applied to the device. The force may be applied externally, in the form of a mechanical device, for example, to cause the device 120 to move. Alternatively, the force may be applied internally, for example, in the form of surface tension within molten solder contact.

In some embodiments, spot size converters may be included at the terminal ends of one or more of the patterned planar waveguides 144 to facilitate the transfer of optical signals from the cavity mounted devices 120 to the waveguides 144. In embodiments, for example, in which the mounted optical devices 120 are emitting devices, such as a laser, the transfer of optical signals from the emitting device to the waveguides 144 can be improved with the inclusion of a spot size converter. In embodiments in which the mounted optical devices are receiving devices, the spot size converter may be included but may not be necessary to improve the signal transfer from the waveguides 144 to the photodiode or other form of receiving device. Optional spot size converters are shown in proximity to the cavity-mounted devices 120 in the top-down view of FIG. 1C(a).

FIG. 1C shows schematic top-down and section views of an embodiment of an interposer-based PIC assembly 118 comprised of multicore fiber 154, mounted optical devices 120, and PIC structure 102. The top-down view is shown in FIG. 1C(a), Section A-A′ from FIG. 1C(a) is shown in FIG. 1C(b), and Section B-B′ is shown in the INSET in FIG. 1C(a). Multicore fiber 154 is shown on interposer PIC structure 102 within lateral alignment aids 106. The optical axes of the cores 156 of the multicore fiber 154, in a preferred embodiment, are aligned with the optical axes of the terminal ends of the patterned planar waveguides 144 or the optional spot size converters 115 of the fanout waveguide structure 112. The cross section of multicore fiber 154, in the embodiment shown in FIG. 1C, is further shown in the INSET of FIG. 1C(a). (Note: The dimensional scale of the cross section is reduced in Section B-B′.) The multicore fiber 154 shows a linearly array comprised of four cores in the embodiment that are aligned to the patterned planar waveguides 144 of the fanout waveguide structure 112. In other embodiments, other arrays of cores may be used as further described herein.

In the assembly 118, the fanout waveguide structure enables the multiple channels of the multicore fiber and the multiple cavity-mounted devices 120 to be coupled. In embodiments, optical device 120 may be an emitting device, such as a laser, a receiving device, such as a photodiode, among other optical devices. In an embodiment of the assembly 118, one or more emitting devices may be mounted or otherwise formed on the PIC structure 102, as for example, in the formation of a multiplexing device. In another embodiment, one or more receiving devices may be mounted or otherwise formed on the PIC structure 102, as for example, in the formation of a demultiplexing device. And in yet other embodiments, a combination of one or more emitting devices and one or more receiving devices may be mounted or otherwise formed on the PIC structure 102 as for example, in the formation of a device with multiplexing and demultiplexing functionality. In other embodiments, other devices and combinations of optical devices may be mounted or otherwise formed onto the PIC structure 102.

Coupling of the linearly configured four-core optical fiber 154, in the embodiment shown in FIG. 1C, to the terminal ends of the fanout waveguide manifold 113 on the interposer-based PIC 118, allows for the simultaneous alignment of the optical fiber cores 156 of the multicore fiber 154 to the individual waveguides 144 or optional spot size converters 115 of the four-waveguide fanout structure 112.

In embodiments, as further described herein, the functionality of the PIC assembly 118 is improved with the increased quality of the alignment of the cores 156 of the multicore optical fiber 154 with the waveguides 144 of the interposer-based PIC 118, and further improved with the increased quality of the alignment of the waveguides 144 with the optical axes of mounted optoelectrical devices 120.

The lateral alignment aids 106, in conjunction with vertical alignment provided with the formation of the v-groove or trench, facilitate improved alignment between the cores of the multicore fiber 154 and the terminal ends of the waveguides 144. The formation of the waveguides 144 and the lateral alignment aid 106 from a same hard mask 116, and from all or a portion of a same planar waveguide layer 105, provides accurate lateral positioning within the resolution provided by the lithographic patterning step for the hard mask pattern, and the etch or other patterning steps for the hard mask and the planar waveguide layer and underlayers below the planar waveguide layer.

With regard to the alignment between the optical axes of the patterned planar waveguides 144 with the optical axes of the cavity mounted devices 120, similar improvements in the quality of the coupling can be realized with the formation of the alignment aids 134 from the same patterned hard mask 116.

Improved coupling quality may be measured for example, by the power loss at the interface between two coupled devices or features. Low power loss at the interface is typically indicative of good coupling.

The inclusion of one or more aligned fiducials 114 further facilitates effective positioning of mounted devices using automated pick and place equipment. In the embodiment shown, fiducial 114 is shown in fiducial cavity 149. Fiducial cavity 149 can improve the visibility of the fiducial in embodiments in which the fiducial is covered with a thick dielectric. In embodiments for the dielectric is thin or significantly transparent, the fiducial cavity may not be required.

FIG. 1D shows schematic top-down and section views of an embodiment of an interposer-based PIC assembly 118 comprised of multicore fiber 154, mounted optical devices 120, and PIC structure 102, for a PIC structure 102 that includes one or more PIC device 140. The top-down view is shown in FIG. 1D(a) and Section A-A′ from FIG. 1D(a) is shown in FIG. 1D(b). PIC device 140 may be, for example, a modulator, a lens, a filter, an attenuator, a waveguide, a reflector, or any optical device or combination of devices formed all or in part from the planar waveguide layer 105, mounted into the PIC structure 102, or otherwise formed to couple to all or a portion of one or more of the waveguides 144 in the fanout waveguide 112. PIC device 140 may be coupled to the cavity mounted devices 120 in some embodiments through patterned planar waveguides 140 or optional spot size converters 115. In some embodiments, device 140 may be coupled directly to the cavity mounted devices 120.

FIG. 1E(a) shows an end view of multicore fiber from FIG. 1C (looking through fiber into SSC manifold).

FIG. 1E(b) shows an enlarged cross section view of multicore fiber and fiber mounting portion of PIC structure 102.

FIG. 1E(a) shows an end view of an embodiment of an interposer PIC assembly 118 comprised of an interposer PIC structure 102 and multicore fiber 154. Multicore fiber 154 is shown positioned in a v-groove 150 formed in interposer base structure 101. The end view in FIG. 1E(a) shows the four cores 156 in a linear array as in FIGS. 1A-1D, in alignment with the terminal ends of patterned planar waveguides 144 or optional spot size converters 115. In the embodiment shown in FIG. 1E(a), vertical alignment of the cores 156 is provided by the v-groove 150. In other embodiments, a fiber mounting block may be used.

The patterned planar waveguide 144, in the embodiment, is shown comprised of top and bottom cladding layers 105_{cladding} and a core layer 105_{core}. Lateral alignment aid 106 is formed from hard mask layer 116. In an embodiment, cavity 147 may be formed with a photoresist mask patterning of layer 138 using a selective etch process to remove exposed portions of dielectric layer 138 without removal of the hard mask layer 116 to a depth at or near to the interface between the layer 138 and the base structure 101, followed by a v-groove forming step.

FIG. 1E(b) shows an enlarged cross section of another embodiment of assembly 118 comprising a multicore fiber 154 and a portion of the PIC structure 102. This figure shows alignment of the optical axis 107b of a core 156 of the multicore fiber 154 with the optical axis 107a of a spot size converter 115 formed in manifold 113. The embodiment shows core layer 105_{core} with top and bottom cladding layers 105_{cladding} comprising planar waveguide layer 105. In this embodiment, the planar waveguide layer is formed on optional underlying dielectric layer 138 on electrical interconnect layer 103 on substrate 100, and another dielectric layer 138 is shown on the planar waveguide layer 105. Cladding 155 of the multicore fiber 154 is also shown.

Alignment of the optical axes 107b of the multicore fiber 154 with the optical axes 107a of the spot size converters 115, is facilitated by the formation of the planar waveguides 144, the waveguide portions of the spot size converters 115, and the boundaries of the lateral alignment aid 106 from the same planar waveguide layer 105, and the use of a single hard mask layer for the patterning of these features.

FIG. 1E(a) shows an end view of an embodiment of an assembly 118 comprised of PIC structure 102 and multicore fiber 154 positioned in a v-groove 150 formed in interposer base structure 101. This end view shows the four cores 156 in a linear array as in FIGS. 1A-1D, in alignment with the terminal ends of patterned planar waveguides 144 or optional spot size converters 115. Accurate lateral positioning is provided by the lateral alignment aid 106. Lateral alignment aid 106 is formed from the planar waveguide layer 105 in the embodiment and forms a boundary for the formation of v-groove 150. Planar waveguide layer 105 is comprised of a waveguide core for optical signal propagation and cladding layers that provide confinement of the optical signal to the waveguide core. The patterned planar waveguide 144, in the embodiment, is shown comprised of top and bottom cladding layers 105_{cladding} and a core layer 105_{core}. Lateral alignment aid 106 is formed from hard mask layer 116. In an embodiment, cavity 147 may be formed with a photoresist mask patterning of layer 138 using a selective etch process to remove exposed portions of dielectric layer 138 without removal of the hard mask layer 116 to a depth at or near to the interface between the layer 138 and the base structure 101, followed by a v-groove forming step. In an embodiment, the waveguide core is a layer of silicon oxynitride and the upper and lower cladding layers are silicon dioxide. In other embodiments, the waveguide core is a layer of silicon oxynitride and the cladding layers are silicon oxynitride with a lower refractive index than that of the core layer. In other embodiments, the waveguide core is a stack of silicon oxynitride layers with a composite refractive index that is greater than the refractive index of the cladding layers. It should be understood that a wide range of planar waveguide structures can be utilized for the formation of the planar waveguide layer 105. In preferred embodiments, the planar waveguide layer 105 is a structure comprised of a silicon oxynitride core of approximately 2-3 microns in thickness and with top and bottom cladding layers also formed from silicon oxynitride having a lower refractive index than that of the core layer.

Section B-B′ shown in the INSET of FIG. 1C(a) shows a cross-section of a linearly configured, four-core optical fiber. The cores 156 are formed in cladding 155 of the multicore fiber. In a typical optical fiber, the diameter of a core is typically on the order of 5-10 microns, and the diameter of the outside cladding of the optical fiber is approximately 125 microns. The typical diameter of coatings and jackets applied to the cladding can be 250 microns. The drawings are thus not drawn to scale to enable features of the multicore fiber 154, features of the fiber mounting, and the alignment of the cores 156 of the fiber 154 to the waveguides 144 on the interposer-based PIC 102 to be shown on the same drawings. In the embodiment shown in the INSET of FIG. 1C(a), the cores 156 are shown to be linearly configured and evenly spaced across a diameter of the encasing cladding 155 of the multicore fiber 154.

In embodiments, the spacings of the waveguides 144 in the fanout waveguide structure 112, are aligned with the spacings of the cores 156 of the linearly configured multicore fibers 154. In other embodiments, the spacings of the optional spot size converters 115, coupled to the waveguides 144 in the fanout waveguide structure 112, are aligned with the spacings of the cores 156 of the linearly configured multicore fibers 154.

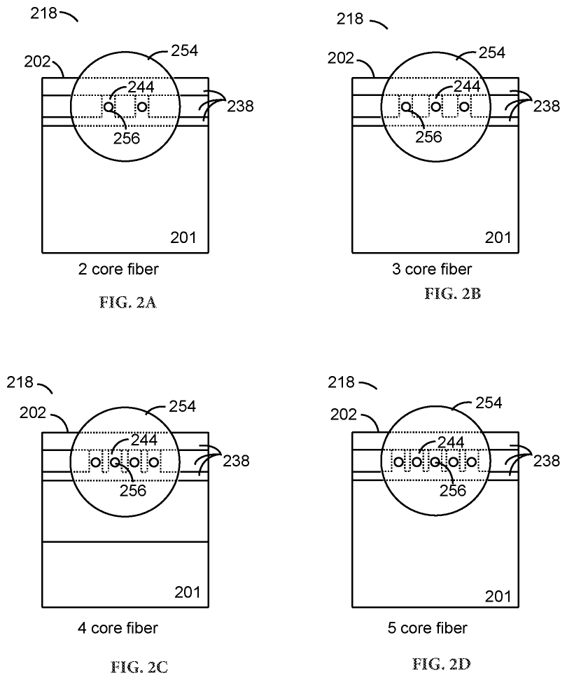

FIGS. 2A-2D show a number of embodiments of interposer-based PIC assemblies 218 having multicore fibers 254 in which the linear arrays of cores 256 of these fibers are positioned in alignment with the patterned planar waveguides 244 shown on portions of interposer-based PIC structures 202. The schematic drawings in FIG. 2 show end views of a fanout waveguide structure containing two or more waveguides 244 (dotted lines) with the multicore fibers 254 (solid lines). V-grooves or other fiber mounting features are not shown. FIG. 2A, 2B, 2C, and 2D show multicore fibers having 2, 3, 4, and 5 linearly configured cores, respectively. In the embodiments shown in FIG. 2, each of the cores 256 of the multicore fibers 254 are shown in alignment with a patterned planar waveguide 244 on the interposer PIC structure 202, although in other embodiments, not all of the cores 256 need be in alignment with a waveguide 244. Optional dielectric layers 238 are shown above, below, and between the patterned planar waveguides 244. Waveguides 244 are comprised of a core layer within which optical signals propagate and top and bottom cladding layers. Dielectric layers 238 can provide side cladding for the waveguides 244. Interposer base structure 201 is also shown in FIGS. 2A-2D. The linearly arranged cores of the multicore fiber 254 in the embodiments shown in FIG. 2 have a single linear array of cores 256.

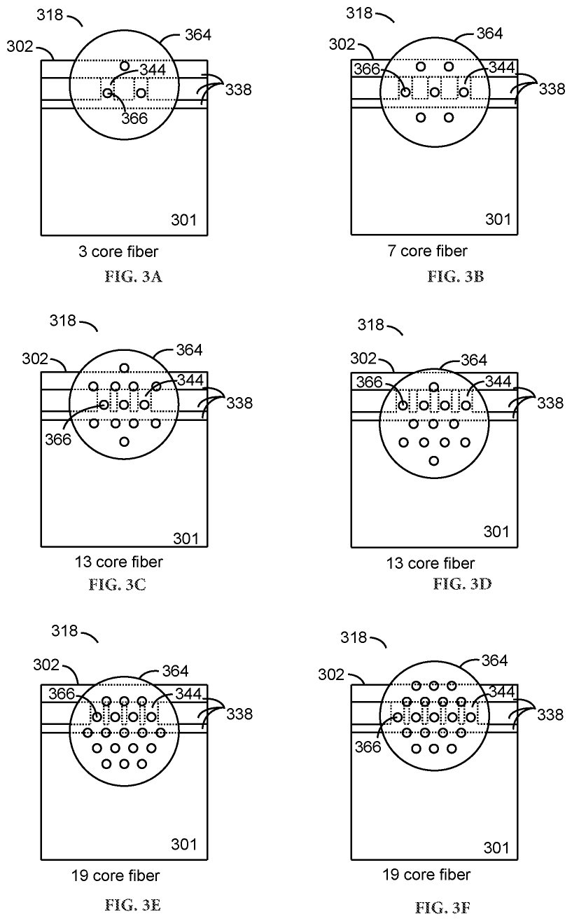

FIG. 3 shows a number of embodiments of interposer-based PIC assemblies 318 having multicore fibers 364 in which the linear arrays of cores 366 of these fibers are positioned in alignment with the patterned planar waveguides 344 shown on portions of interposer-based PIC structures 302. In the embodiments shown in FIG. 3, cores 366 of multicore fiber 364 are not of a single linear array but rather the configurations of cores 366 have portions that are linearly configured. The multicore fibers 364 are shown on interposer-based PIC structures 302. In the embodiment in FIG. 3(a), two linearly aligned cores 366 of a three-core fiber 364 are shown in alignment with two waveguides 344 of a fanout waveguide structure of an interposer-based PIC structure 302 to form assembly 318. Similarly, in the embodiment in FIG. 3(b), three linearly aligned cores 366 of a seven-core fiber 364 are shown in alignment with three waveguides 344 of a fanout waveguide of an interposer-based PIC structure 302 to form assembly 318. In the embodiment in FIG. 3(c), three linearly aligned cores 366 of a thirteen-core fiber 364 are shown in alignment with three waveguides 344 of a fanout waveguide of an interposer-based PIC structure 302 to form assembly 318. In the embodiment in FIG. 3(d), four linearly aligned cores 366 of a thirteen-core fiber 364 are shown in alignment with four waveguides 344 of a fanout waveguide portion of an interposer-based PIC structure 302 to form assembly 318. In the embodiment in FIG. 3(e), four linearly aligned cores 366 of a nineteen-core fiber 364 are shown in alignment with four waveguides 344 of a fanout waveguide portion of an interposer-based PIC structure 302 to form PIC assembly 318. And in the embodiment in FIG. 3(f), five linearly aligned cores 366 of a nineteen-core fiber 364 are shown in alignment with five waveguides 344 of a fanout waveguide portion of an interposer-based PIC structure 302 to form assembly 318. In the embodiments shown in FIG. 3, the quantity of the portions of the linearly configured cores 366 of the multicore fibers 364 are the same as the quantity of waveguides 344 in the fanout waveguide structure. In other embodiments, not all of the cores 366 of the linearly configured portion of the multicore fiber 364 need be in alignment with a waveguide 344.

In the embodiments shown in FIG. 3, optional dielectric layers 338 are shown above, below, and between the planar waveguides 344. Interposer base structure 201 is also shown in FIGS. 3A-3F. The linearly arranged cores of the multicore fiber 254 in the embodiments shown in FIG. 3 have a multitude of cores from which linear array of cores 366 can be aligned with the patterned planar waveguides 344.

### Method of Forming Self-Aligned PIC Assemblies Having Linearly Configured Cores in a Multicore Fiber

In the following paragraphs, methods of formation of embodiments of PIC structures having a fanout waveguide and assemblies that includes these PIC structures are disclosed.

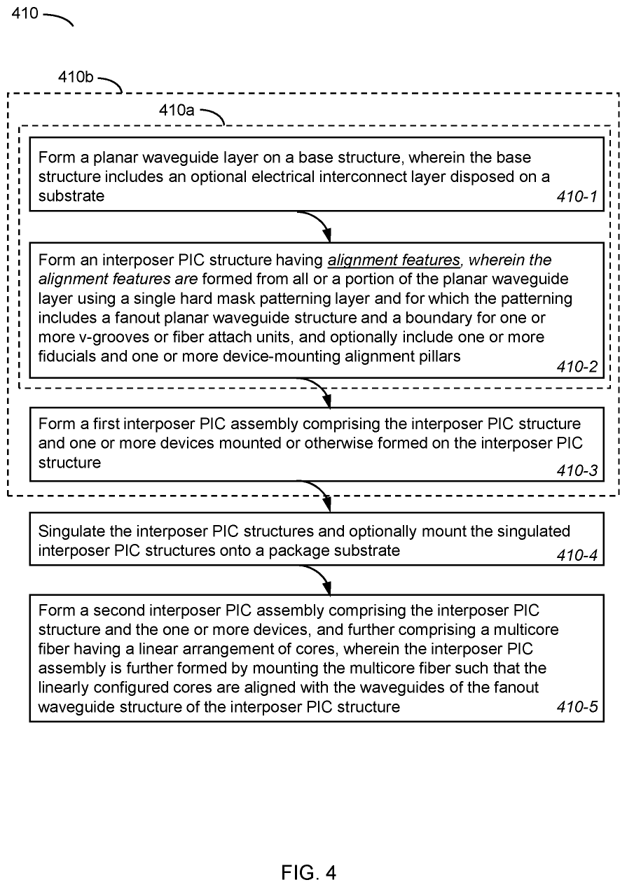

FIG. 4 shows a flow chart for method 410 of forming an embodiment of an interposer-based PIC assembly that includes a linearly configured multicore fiber and a PIC structure having a fanout waveguide structure.

Step 410-1 of method 410, shown in FIG. 4, is a forming step in which a planar waveguide layer is formed on an interposer base structure, wherein the interposer base structure is comprised of an optional electrical interconnect layer and a substrate.

Step 410-2 of method 410 is a forming step in which an interposer PIC structure is formed having alignment features, wherein the alignment features are formed from all or a portion of the planar waveguide layer using a single hard mask patterning layer and for which the patterning includes a fanout planar waveguide structure and a boundary for one or more v-grooves, trenches, or fiber attach units, and optionally include one or more fiducials and one or more device mounting alignment pillars.

The method portion 410a of method 410 is comprised of Steps 410-1 and 410-2 that describe an embodiment of a method of forming an interposer PIC structure.

Step 410-3 of method 410 is a forming step in which a PIC assembly is formed comprising the interposer PIC structure and one or more devices mounted or otherwise formed on the interposer PIC structure.

The method portion 410b of method 410 is comprised of Steps 410-1, 410-2, and 410-3 that describe an embodiment of a method of forming an interposer PIC assembly comprising an interposer PIC structure and one or more devices mounted or otherwise formed on the interposer PIC structure.

Step 410-4 of method 410 is a singulation step in which the interposer PIC structures, typically formed in large quantities at a wafer level, are singulated into individual die for further processing. Upon singulation, the interposer PIC structures may be optionally mounted or otherwise combined with a mounting substrate.

Step 410-5 is a forming step of method 410 in which an interposer PIC assembly is formed comprising the interposer PIC structure having a fanout waveguide and the one or more devices, and is further comprising a multicore fiber having a linear arrangement of cores, wherein the interposer PIC assembly is formed by mounting or otherwise coupling the linearly configured cores of the multicore fiber in alignment with the waveguides of the fanout waveguide structure.

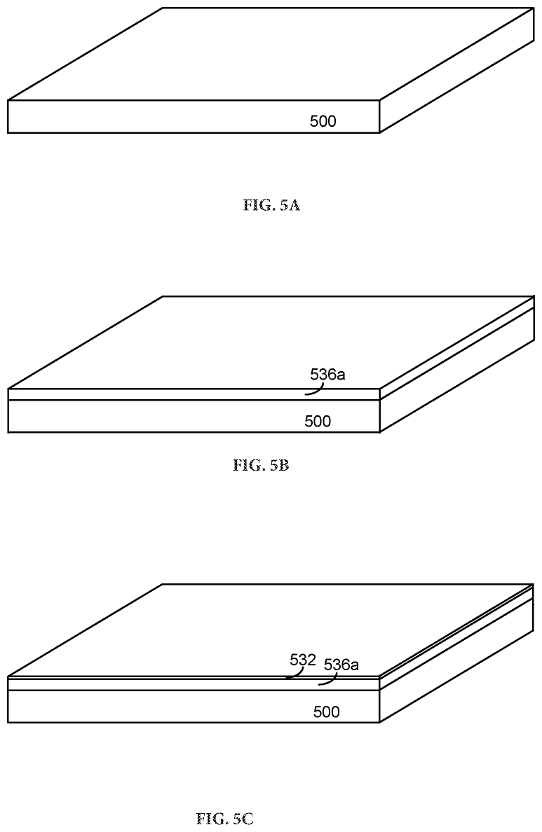

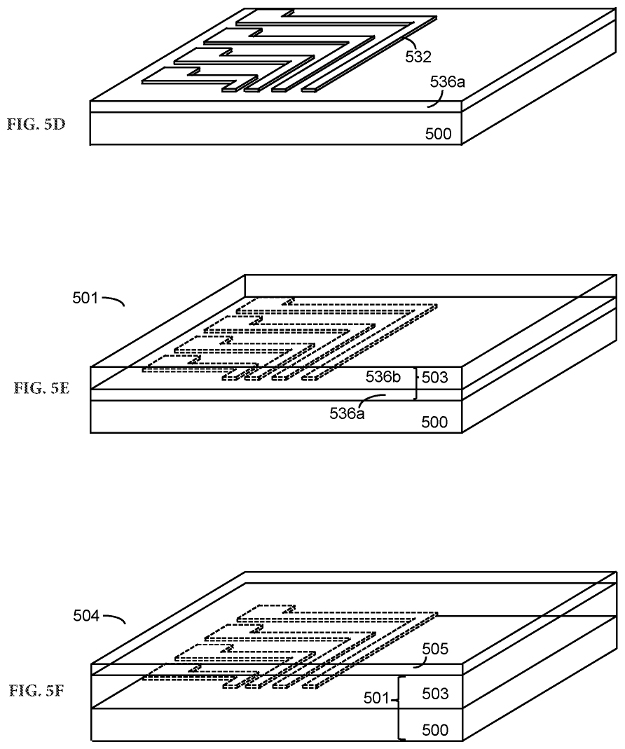

Perspective drawings that illustrate the various steps in the formation of the interposer-based PIC having a fanout waveguide structure are provided in FIGS. 5-12. Accordingly, the flow chart in FIG. 4 for method 410 is described in conjunction with the perspective drawings provided in FIGS. 5-12.

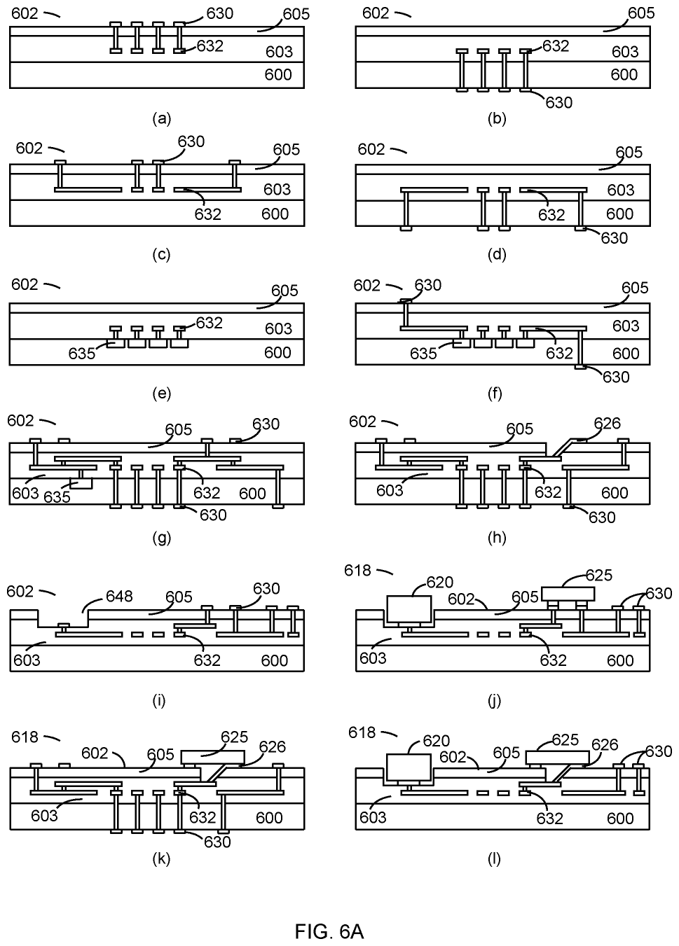

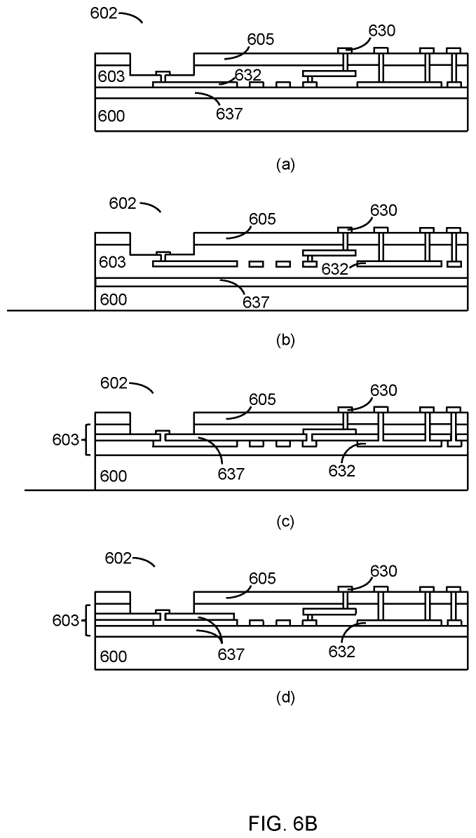

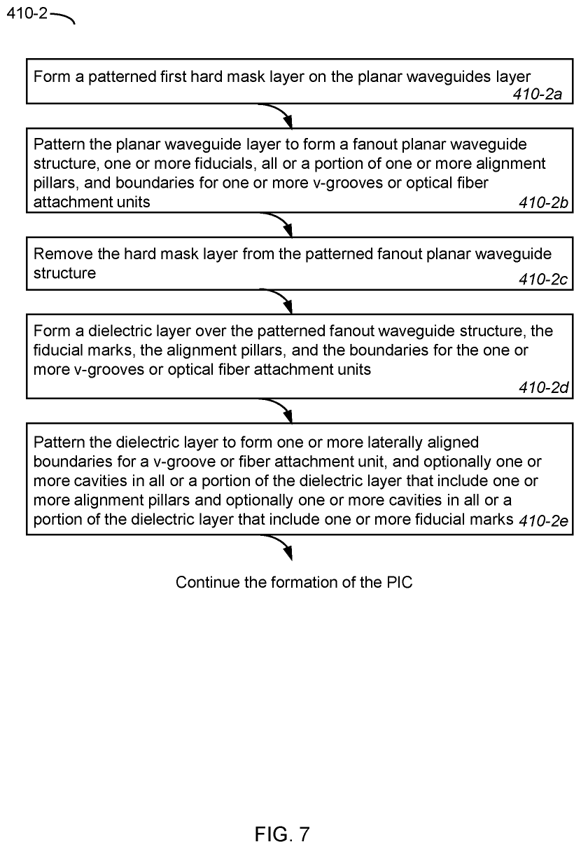

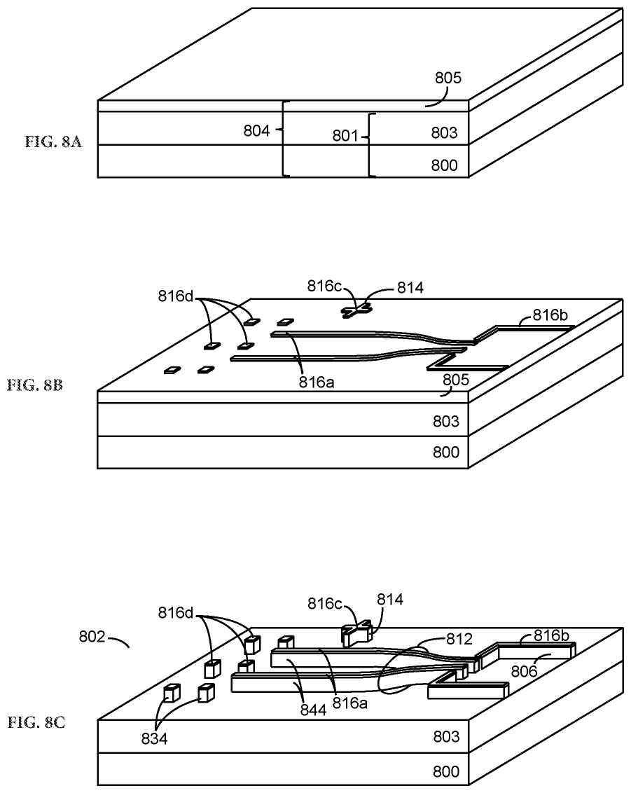

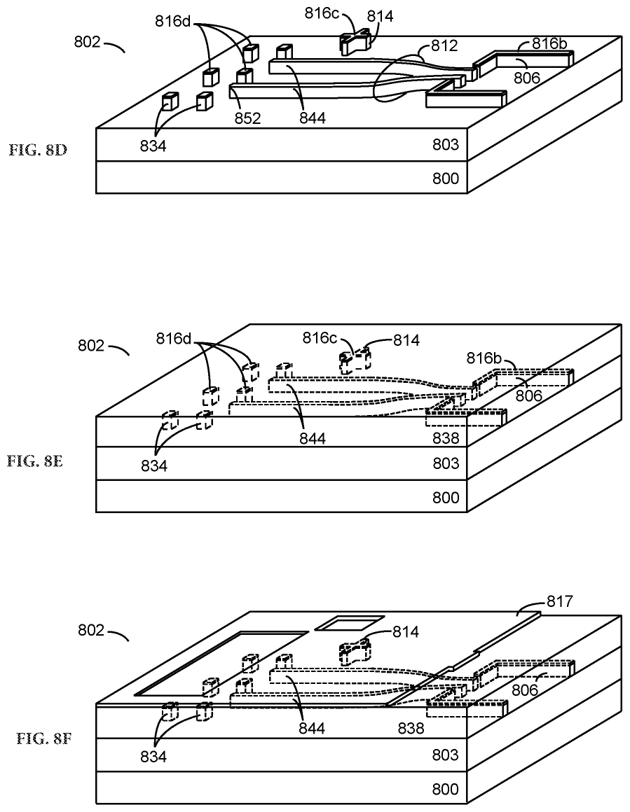

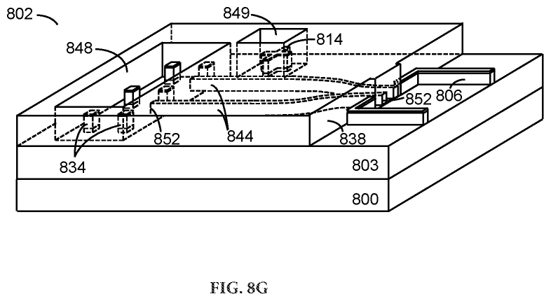

FIGS. 5A-5F show an embodiment of a sequence of steps of method 410a of the method 410 shown in the flowchart of FIG. 4. This sequence of steps describes the formation of the interposer structure with details on the formation of the electrical interconnect layer. Some example configurations of the metallization layers in the electrical interconnect layer are provided in FIG. 6A. And in FIG. 6B, some example configurations that include the use of thermally conductive insulating layers in the intermetal dielectric layers of the electrical interconnect layer are shown. FIG. 7 shows an embodiment of a more detailed flowchart of the formation of embodiments of the interposer PIC structures and assemblies. FIG. 8 shows a sequence of perspective drawings to further illustrate the steps in the flowchart of FIG. 7, with details on the use of a single hard mask in the formation of the fanout waveguide structure on the interposer PIC structure, the boundary for aligning a multicore fiber onto the interposer PIC structure, one or more fiducials, and one or more alignment pillars to facilitate alignment of mounted devices onto the interposer PIC structure. The addition of mounted devices and one or more multicore fibers to the interposer PIC structures is also described in FIGS. 8-12 to form embodiments of interposer PIC assemblies.

FIG. 5A shows a substrate 500.

FIG. 5B shows a substrate having a dielectric layer 536a.

FIG. 5C shows a substrate having a dielectric layer 536a and unpatterned electrically conductive layer 532.

FIG. 5D shows a substrate having a dielectric layer 536a and patterned electrically conductive layer 532.

FIG. 5E shows a substrate 500 having an electrical interconnect layer 503 comprised of dielectric layer 536a, a patterned electrically conductive layer 535, and a top dielectric layer 536b to form interposer base structure 501.

FIG. 5F shows an embodiment of an interposer structure 504 having a planar waveguide layer 505 on base structure 501 comprised of substrate 500 and electrical interconnect layer 503.

Step 410-1 of method 410, shown in FIG. 4, is a forming step in which a planar waveguide layer 505 is formed on an interposer base structure 501, wherein the interposer base structure 501 includes an optional electrical interconnect layer 503 disposed on a substrate 500 as shown in the sequence of perspective drawings in FIGS. 5(a)-5(g). This sequence of drawings illustrates a method of formation of an embodiment of an interposer comprising a planar waveguide layer 505, an electrical interconnect layer 503, and a substrate 500.

FIG. 5A shows substrate 500. Substrate 500 in preferred embodiments is a semiconductor substrate such as silicon. Other semiconductor materials may also be used, as well as insulating materials, metal materials, and combinations of semiconductor, insulating, and metal layers to form a substrate.

FIGS. 5B-5E illustrate the formation of an embodiment of an electrical interconnect layer 503 on substrate 500 to form base structure 501. FIG. 5B shows a first dielectric layer 536a on substrate 500. First dielectric layer 536a is a first layer of intermetal dielectric layer 536a. First intermetal dielectric layer 536a may be a layer of silicon dioxide, for example. Other dielectrics may also be used. FIG. 5C shows the formation of a conductive metallization layer 532 on insulating dielectric layer 536a. FIG. 5D shows an embodiment of conductive metallization 532 after patterning to form electrical interconnects. FIG. 5E shows the formation of a second layer of intermetal dielectric layer 536b to form interposer base structure 501. In the embodiment shown, one layer of electrically conductive interconnects is provided within the layers of intermetal dielectric 536a,536b. In other embodiments, more than one layer of electrically conductive interconnects may be provided in the electrical interconnect layer 503. In some embodiments, the intermetal dielectric layer 536b may be planarized.

FIG. 5F shows the interposer base structure with the formation of a planar waveguide layer 505. Planar waveguide layer 505 may be comprised of multiple layers including one or more core layers, one or more cladding layers, and may also include spacer layers, buffer layers and other layers. FIG. 5(f) shows interposer structure 504 comprised of the planar waveguide layer formed on the base structure 501 further comprised of electrical interconnect layer 503 and substrate 500.

It should be noted that the optional interconnect layer 503 may not be required in some embodiments that do not include optoelectrical or electrical devices. PIC structures may be formed, for example, in some embodiments with optical devices that do not require electrical interconnections, and for these embodiments, the electrical interconnect layer 503 may not be included.

FIG. 6A shows various schematic drawings of example configurations for the electrical interconnect layer 503 and in particular, the routing of the electrically conductive layer 532 within the electrical interconnect layer 503 and from within the electrical interconnect layer 503 to locations at the front and back surfaces of the interposer structure 504.

In FIGS. 6A(a)-6A(l), the front side of the interposer PIC structure 602 is the closer to the top of the page and the back side of the interposer PIC structure 602 is the closer to the bottom of the page with the label “FIG. 6A” positioned at the bottom of the page.

FIG. 6A(a) shows an embodiment of the electrically conductive layer 632 with connections formed to the top surface of the interposer PIC structure 602. In the embodiment shown, the planar waveguide layer 605 may include a top dielectric layer such as a spacer layer, a buffer layer, a planarization layer or other layer. Electrical contacts 630 are formed at the top surface as shown to accommodate electrical connections to mounted devices and to other locations on the interposer-based PIC, via for example, wire bonding or other metallization schemes. Electrical contacts 630 may also facilitate mounting of the interposer to another interposer, submount, or other device.

FIG. 6A(b) shows an embodiment of interposer PIC structure 602 with electrically conductive layer 632 of interconnect layer 603 having vertical connections formed to the back surface of the interposer PIC structure 602. FIG. 6A(c) shows an embodiment in which the electrically conductive layer 632 has lateral traces within the electrical interconnect layer 603 and with vertical connections to the top surface of the interposer PIC structure 602 with terminal connections 630. FIG. 6A(d) similarly shows an embodiment having lateral traces within the electrical interconnect layer 603 and with vertical connections to the back surface of the interposer PIC structure 602 also terminating with contacts 630. FIG. 6A(e) shows an embodiment of the interposer PIC structure with electrical interconnect layer 603 having electrically conductive layer 632 that include electrical interconnects that form a contact with embedded devices 635 in the substrate 600. Embedded devices 635 may be, for example, transistors, resistors, capacitors, inductors, or other electrical or optoelectrical devices. FIG. 6A(f) shows an embodiment having lateral traces within the electrical interconnect layer 603 and with vertical connections to embedded devices 635 in the substrate 600 and vertical connections to the front and back of the interposer PIC structure 602 terminating in contacts 630. In other embodiments, the vertical connections may terminate in either the front or back of the interposer PIC structure 602. Embedded devices 635 may be formed in the substrate 600 or in the electrical interconnect layer 603 or another layer in the interposer PIC structure 602.

FIG. 6A(g) shows an embodiment of interposer PIC structure 602 with electrical interconnect layer 603 having multiple electrically conductive layers 632 with vertical interconnections between these layers. This embodiment also shows vertical connections from the electrically conductive lateral traces 632 to contacts 630 formed on the front surface of the interposer PIC structure 602 and vertical connections from the lateral traces 632 to contacts 630 on the back side of the interposer PIC structure 602.

FIG. 6A(h) shows an embodiment similar to that described for FIG. 6A(g) with the addition of an electrically conductive optical reflector structure 626 that also forms an electrical contact between an electrically conductive layer 632 and the top surface of the interposer PIC structure 602.

FIG. 6A(i) shows an embodiment having a cavity formed in the planar waveguide layer 605, and optionally into the intermetal dielectric layer 636. In the embodiment, vertical connections are provided from an electrically conductive layer 632 to the cavity 648. Cavity 648, in the embodiment, enables the mounting of optoelectrical devices, for example, that can be coupled to patterned planar waveguides formed from the planar waveguide layer 605 as shown in FIG. 6A(j). Device 620, in embodiments, may be an optoelectrical device that couples to the waveguide layer 605 or to patterned planar waveguides formed from the waveguide layer 605. Also shown in FIG. 6A(j) is surface mounted device 625 mounted to electrical contacts 630 formed on the top surface of the interposer PIC structure 602 to form interposer PIC assembly 618.

FIG. 6A(k) shows an embodiment of a PIC assembly 618 that includes interposer PIC structure 602 having electrical interconnect layer 603 and surface mounted device 625. The surface mounted device has an electrical contact formed with a contact 630 and another electrical contact formed through the reflector 626, in the embodiment, to an electrical interconnect layer 632. In the embodiment, the surface mounted device can receive a signal from, or deliver a signal to, the planar waveguide layer 605 or patterned planar waveguides formed from the planar waveguide layer 605 with the change in direction provided by the reflector 625. The embodiment shown in FIG. 6A also includes vertical connections to the back surface of the interposer PIC structure 602 of assembly 618.

FIG. 6A(l) shows an embodiment of a PIC assembly 618 comprised of an embodiment of interposer PIC 602 and cavity-mounted device 620 and surface mounted device 625 in which an electrical contact is formed between the surface mounted device 625 and the electrical interconnect layer 632 through reflector structure 626.

In FIGS. 6A(a)-6A(l), embodiments of interposer PIC structures 602 and assemblies 618 that include interposer PIC structures 602 are shown. In these embodiments, various configurations of electrically conductive layer 632 in the electrical interconnect layer 603 are shown. Other configurations that utilize combinations of the features of the embodiments shown are also within the scope of embodiments.

Additionally, patterned electrically conductive traces may also be formed on the top of the planar waveguide layer and on other dielectric layers formed on the planar waveguide layer.

The embodiments shown in FIG. 6A illustrate a number of various configurations of the electrically conductive layer 632 for the electrical interconnect layer 603. In other embodiments, portions of the intermetal dielectric layer 636 can be formed from thermally conductive dielectric layers, for example, to improve the extraction of thermal energy from heat generating portions of the interposer PIC structure 602. FIG. 6B shows some embodiments in which thermally conductive layers are incorporated into the electrical interconnect layer and other portions of the interposer PIC structure 602.

FIG. 6B(a) shows a thermally conductive layer in the EIL

FIG. 6B(b) shows a thermally conductive layer in the substrate

FIG. 6B(c) shows a thermally conductive layer in the EIL

FIG. 6B(d) shows multiple thermally conductive layers.

FIG. 6B(a) shows an embodiment of interposer PIC structure 602 having thermally conductive layer 637 in a portion of the electrical interconnect layer 603. In the embodiment shown, the thermally conductive layer 637 is shown with coverage across the substrate 600. In other embodiments, the thermally conductive layer 637 may occupy a portion of the area of the substrate 600.

Thermally conductive layer 637 is an electrically insulating layer and may be, for example, a layer of aluminum nitride or an alloy of aluminum nitride.

FIG. 6B(b) shows another embodiment of interposer PIC structure 602 having thermally conductive layer 637 in a portion of the substrate 600. In the embodiment shown, the thermally conductive layer 637 is shown with coverage across the substrate 600. In other embodiments, the thermally conductive layer 637 may occupy a portion of the area of the substrate 600.

FIG. 6B(c) shows yet another embodiment of interposer PIC structure 602 having thermally conductive layer 637 in another portion of the electrical interconnect layer 603. In the embodiment shown, the thermally conductive layer 637 is shown within the electrical interconnect layer 603.

FIG. 6B(d) shows yet another embodiment of interposer PIC structure 602 having thermally conductive layer 637 in yet other portions of the electrical interconnect layer 603. In the embodiment shown, the thermally conductive layer 637 is shown above and below the electrically conductive layer 632 of the electrical interconnect layer 603.

Step 410-2 of method 410, shown in FIG. 4, is a forming step in which an interposer PIC structure is formed with vertically and laterally aligned features from the planar waveguide layer 505 that include planar waveguides in the fanout planar waveguide structure, one or more fiducials, one or more alignment pillars, and the boundaries for one or more v-grooves or fiber mounting blocks. Additional details for forming step 410-2 are provided herein in the flowchart of FIG. 7 and the perspective drawings of FIG. 8(a)-8(g).

The method portion 410a of method 410 is comprised of Steps 410-1 and 410-2 that describe an embodiment of a method of forming an interposer PIC structure.

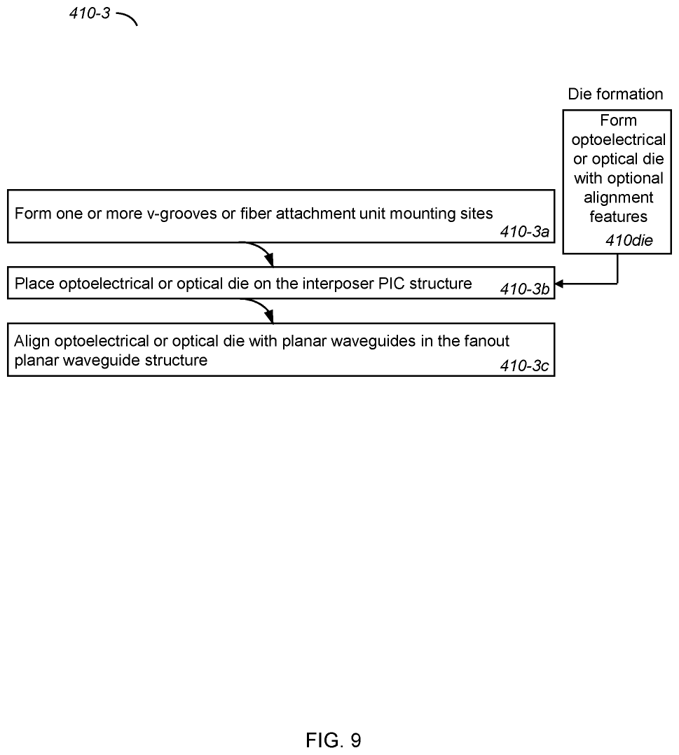

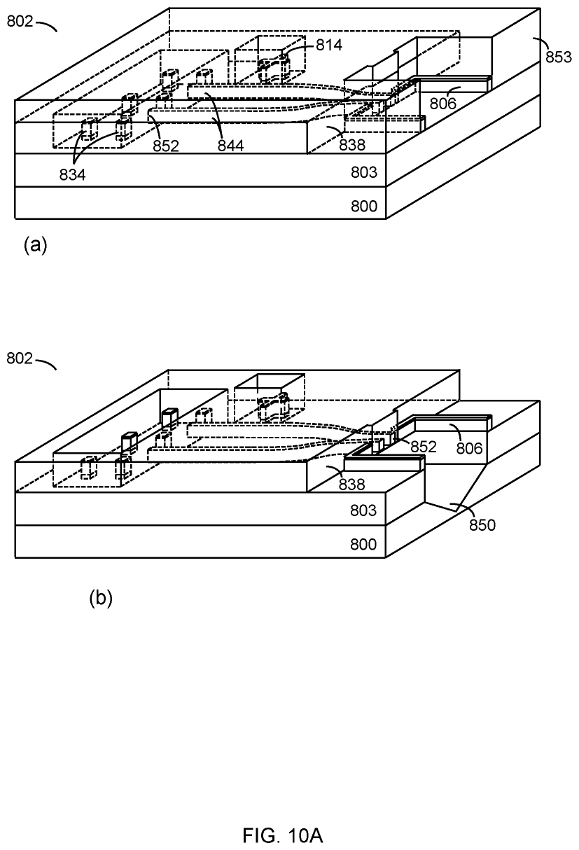

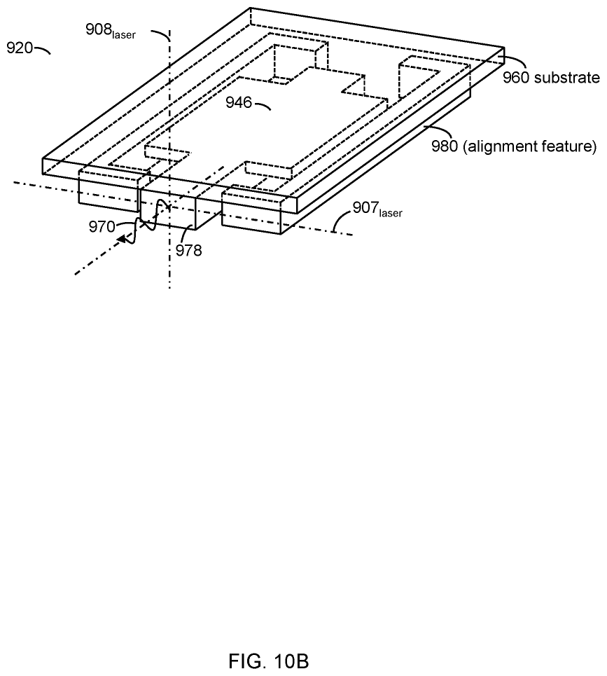

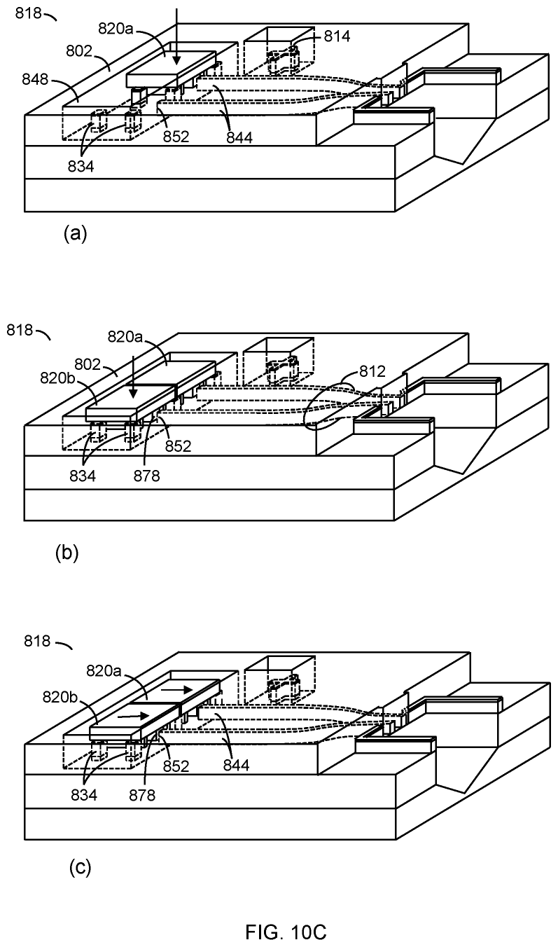

Step 410-3 of method 410, shown in FIG. 4, is a forming step in which an interposer PIC assembly is formed comprising the interposer PIC structure of step 410-2 and one or more devices mounted or otherwise formed on the interposer PIC structure. Additional details for forming step 410-3 are provided herein in the flowchart of FIG. 9 and the perspective drawings of FIG. 10A-10C.

The method portion 410b of method 410 is comprised of Steps 410-1, 410-2, and 410-3 that describe an embodiment of a method of forming an interposer PIC assembly comprising an interposer PIC structure and one or more devices mounted or otherwise formed on the interposer PIC structure.

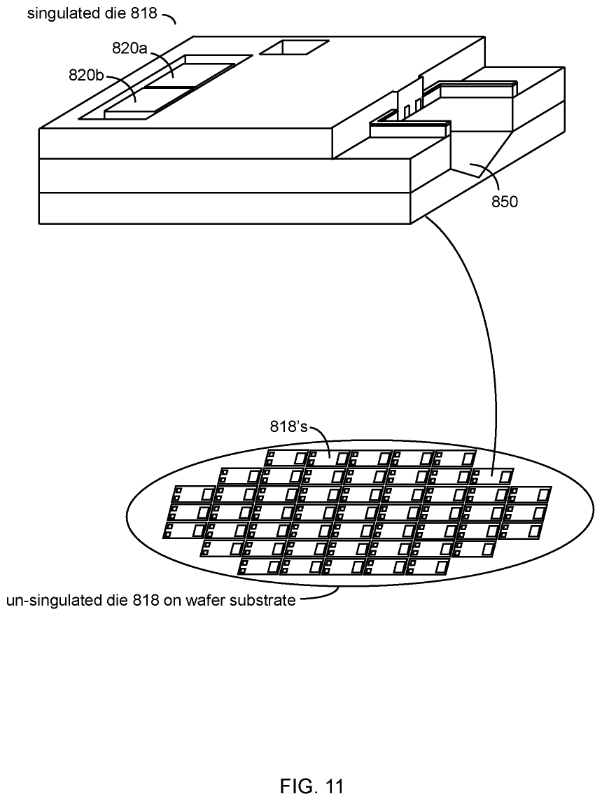

Step 410-4 of method 410, shown in FIG. 4, is a singulation step, within which the interposer-based PICs are singulated from a wafer in an embodiment in which a multitude of PICs are formed using wafer level processing. Wafer level processing is a commonly used method of device fabrication in which many individual die are formed on a large substrate that is subsequently diced into individual devices in the singulation process. Step 410-4 of method 410, shown in FIG. 4, includes an optional mounting step, in which singulated PICs are mounted onto a substrate for subsequent packaging. Singulated PICs may be packaged individually, in multiples, or with other devices. Additional details for forming step 410-4 are provided herein in the perspective drawings of FIGS. 11 and 12.

Step 410-5 of method 410, shown in FIG. 4, is an attachment step in which one or more linearly configured multicore fibers are positioned within the lateral alignment boundary for the multicore fiber and secured in position. In embodiments, attachment step 410-5 can include an alignment step in which a measure of the rotational alignment of the optical axes of the cores of the multicore fiber with the optical axes of the waveguides on the PIC is evaluated. In a preferred embodiment, for example, the optimal power transfer through one or more cores is measured and maximized prior to attachment of the fiber into place on the PIC. Additional details for forming step 410-5 are provided herein in the perspective drawings of FIG. 12.

FIG. 7 shows a flow chart with additional detail for forming step 410-2 of the method 410 for the formation of an embodiment of an interposer PIC structure having a fanout waveguide and alignment features. In the embodiment, these alignment features include the planar waveguides of the fanout waveguide structure, one or more fiducials, one or more alignment pillars, and the boundaries for one or more v-grooves or fiber mounting blocks. Other alignment features may also be included. The inclusion of these alignment features facilitates the alignment of the optical axes of the cores of a multicore fiber with the optical axes of the waveguides in the fanout waveguide structure, and also facilitate the alignment of the optical axes of devices mounted in the interposer PIC structure also with the optical axes of the waveguides in the fanout waveguide structure. An expanded flowchart is provided in FIG. 7 for step 410-2 from FIG. 4. Steps 410-2a to 410-2e show an embodiment for step 410-2 that may be utilized in the formation of these alignment features.

The flow chart of FIG. 7 is described in conjunction with the perspective drawings provided in FIG. 8A-8G.

FIG. 8A shows an Interposer structure comprised of the planar waveguide layer on an interposer base structure.

FIG. 8B shows a first patterned hard mask having portions for fanout waveguide structure, lateral alignment feature for v-groove, fiducials, and alignment pillars (Step 410-2a of FIG. 7).

FIG. 8C shows a patterned planar waveguide layer having portions for fanout waveguide structure, lateral alignment feature for v-groove, fiducials, and alignment pillars. (Step 410-2b of FIG. 7).

FIG. 8D shows selective removal of the hard mask (Step 410-2c of FIG. 7).

FIG. 8E shows dielectric layer (Step 410-2d of FIG. 7).

FIG. 8F shows a second patterned hard mask (part 1 of Step 410-2e of FIG. 7).

FIG. 8G shows formation of device mounting cavities, fiducial cavity, and lateral alignment feature for v-groove and removal of the second patterned hard mask (part 2 of Step 410-2e of FIG. 7).

Referring to FIG. 7, Step 410-2a of method 410-2 is a forming step in which a first patterned hard mask layer 816 is formed on the planar waveguide layer 805. FIG. 8A shows an interposer structure 804 comprised of planar waveguide layer 805 on the interposer base structure 801 further comprised of electrical interconnect layer 803 and substrate 800. First hard mask layer 816, formed on planar waveguide layer 805, includes pattern 816a for the formation of one or more patterned planar waveguides of a fanout waveguide structure, pattern 816b for the formation of all or a part of a boundary for one or more lateral alignment aids for aligning an optical fiber, pattern 816c for the formation of one or more fiducials, and pattern 816d for the formation of one or more alignment pillars for alignment of cavity mounted devices. Embodiments of hard mask patterns 816a-816d are shown in FIG. 8B. In a preferred embodiment, patterned hard mask 816 is formed from an aluminum layer, or an alloy of aluminum. Aluminum, and aluminum-containing alloys, have a high resistance to the plasma etching chemistries using in the patterning of silicon dioxide layers, silicon nitride layers, and silicon oxynitride layers that may be used in the formation of the planar waveguide layers and other layers in the interposer structure 804 in some embodiments. Other hard mask materials can also be used.

The hard mask pattern 816a shown in FIG. 8B, includes features for the formation of two planar waveguides in a fanout waveguide structure, as further described herein. Two planar waveguides are shown in the fanout waveguide structure for simplicity and clarity in this description although in other embodiments more than two waveguides may be included in the fanout waveguide structure as further described herein.

Step 410-2b of method 410-2 of FIG. 7 is a patterning step in which the planar waveguide layer 805 is patterned to form one or more planar waveguides 844 for a fanout waveguide structure 812, boundaries 806 for one or more lateral alignment aids for alignment of an optical fiber, one or more fiducials 814, and one or more alignment pillars 834. The planar waveguide layer 805 after patterning is shown in FIG. 8C. Formation of each of the patterned features 816a-816d from a same hard mask layer 816, and from a same planar waveguide layer 805 ensures that these features are aligned within the tolerance of the lithographic process used in the patterning of the hard mask layer 816. After an etch patterning step, as shown in the embodiment in FIG. 8C, pattern 816a yields patterned planar waveguides 844 of fanout waveguide structure 812, pattern 816b yields boundary 806 for the lateral alignment of a multicore fiber, pattern 816c yields fiducial 814, and pattern 816d yields alignment pillars 834 for the alignment of cavity mounted devices.

Step 410-2c of method 410-2 of FIG. 7 is a removing step in which the patterned hard mask layer 816a is removed from the patterned fanout waveguide structure 812. Removal of the patterned hard mask 816a from the patterned waveguide layers 844 of the fanout waveguide structure 812, illustrated in FIG. 8D, is required for efficient propagation of optical signals through the waveguide structure and for further processing of the fanout waveguide structure 812. The patterned hard mask layer 816d on the alignment pillars 834 is required for further processing and is not removed in this step. In preferred embodiments, patterned hard mask layer 816c on the fiducial 814 and patterned hard mask layer 816d on the alignment boundary 806 for the multicore fiber are not removed, although in some embodiments, one or more of the patterned hard masks 816c on the fiducial 814 and the patterned hard mask 816d on the multicore alignment boundary 806 may be removed with appropriate changes made to the process flow to accommodate such removal. In embodiments, the removal of the patterned hard mask 816b from the planar waveguides 844 can be performed with the application of a mask layer such as a photoresist layer. This mask layer is applied to the interposer structure and removed from portions of the hard mask 816a that are to be removed, and kept in place over portions of the hard mask 816b, 816c, and 816d, for example, that are to remain for further processing. The exposed hard mask 816a is then exposed to an etch process to remove the hard mask in the exposed portions of the partially formed interposer PIC structure 802. The photoresist layer is then removed for subsequent processing.

Step 410-2d of method 410-2 of FIG. 7 is a forming step in which a dielectric layer 838 is formed over the patterned fanout waveguide structure 812, the fiducial marks 814, the alignment pillars 834, and the boundary 806 for the lateral alignment of a multicore fiber. Layer 838 is shown on partially formed interposer PIC structure 802 in FIG. 8E. In a preferred embodiment, dielectric layer 838 is a layer of silicon dioxide or a layer of silicon oxynitride with an index of refraction that is less than that of the core of the planar waveguide layer 805. Encapsulation of the fanout waveguide structure 812 with a lower refractive index material facilitates confinement of the optical signal to the cores of the waveguides 844. In some embodiments, dielectric layer 838 is a planarized layer.

Step 410-2e of method 410-2 of FIG. 7 is a forming step in which a cavity 848 is formed in the dielectric layer 838 to further form the alignment pillars 834, a cavity 849 is optionally formed to remove dielectric layer 838 from the one or more fiducial marks 814, and the dielectric layer 838 is removed within the boundary 806 to reveal the boundary layer and to enable subsequent formation of a v-groove or other form of mounting site for an optical fiber within the boundary 806. The steps in the formation of cavity 848 and optional cavity 849, and the removal of the layer 838 from within the boundary 806 to enable subsequent formation of a v-groove or other optical fiber mounting site is illustrated in FIGS. 8F-8G.

In FIG. 8F, the formation of a second patterned hard mask 817 is shown on the dielectric layer 838. In preferred embodiments, the second hard mask layer 817 is formed from aluminum or an alloy of aluminum. In other embodiments, other materials can be used to form the second hard mask layer 817. Openings are provided in the hard mask layer 817 for the formation of the cavities 848, 849. In the embodiment shown in FIG. 8, an opening in mask 817 is provided to enable removal of the dielectric layer 838 in proximity to the lateral alignment feature 806 that enables subsequent formation of a v-groove or other form of optical fiber mounting site. Variations in the sizes and shapes of the openings in the hard mask 817 for the formation of the cavities 848,849 and for the removal of the dielectric layer 838 in proximity to the boundary 806 are within the scope of embodiments.

FIG. 8G shows an embodiment of a partially completed interposer PIC structure 802 after removal of the exposed portions of the dielectric layer 838 and removal of the hard mask 817. The figure shows the formation of the cavity 848 and cavity 849, and shows the structure 802 after removal of the dielectric layer 838 in proximity to the lateral alignment feature 806. In the embodiment shown in FIG. 8G, a cavity 849 is formed to remove the dielectric layer 838 in proximity to the fiducial 814. In other embodiments, the dielectric layer 838 may not be removed in proximity to the fiducial 814.

Formation of the cavity 848 and the exposure of the boundary for the lateral alignment aid 806 results in the formation of facets 852 of the waveguides 844 in the embodiment. In the embodiment shown, these facets 852 are formed in one or more walls of the cavity 848 and in proximity to the lateral alignment aid 806 as shown in FIG. 8G.

It should be noted that the height of the alignment pillars 834 after the formation of the cavity 848 may be increased in comparison to the height of the alignment pillars 834 prior to the cavity forming step 410-2e. Additional clearance, for example, for cavity-mounted devices may be provided such that an etch step extends into underlying dielectric layers in the cavity forming dielectric etch step, for example, or to expose, or facilitate exposure of electrical contacts below the cavity 848 as described herein.

FIG. 9 shows a flow chart with additional detail for forming step 410-3 of the method 410 shown in the flowchart in FIG. 4 for the formation of an embodiment of a first PIC assembly comprising the interposer PIC structure and one or more devices mounted or otherwise formed on the interposer PIC structure. In embodiments, the planar waveguide layer on the base structure and the interposer PIC structure are firstly formed as described herein for steps 410-1 and 410-2, respectively. Steps 410-3a to 410-3c show an embodiment for a method of formation for step 410-3. The flow chart of FIG. 9 is described in conjunction with the perspective drawings provided in FIGS. 10A-10C.

FIG. 10A(a) shows the formation of a third patterned mask layer.

FIG. 10A(b) shows the formation of a v-groove (STEP 410-3a of FIG. 9).

FIG. 10C(a) shows placement of a cavity-mounted device (Part 1 of STEP 410-3b of FIG. 9).

FIG. 10C(b) shows placement of another mounted device (Part 2 of STEP 410-3b of FIG. 9).

FIG. 10C(c) shows alignment of mounted devices (STEP 410-3c of FIG. 9).

Referring to FIG. 9, Step 410-3a of method 410-3 is a forming step in which one or more v-grooves, trenches, or fiber attachment unit mounting sites are formed on the interposer PIC structure 802. FIG. 10A(a) shows an interposer structure 802 after formation of a patterned mask layer 853. Patterned mask layer 853 may be, for example, a photoresist mask layer. Other mask layer materials and combinations of materials may also be used. FIG. 10A(a) shows patterned area in proximity to alignment feature 806 that enables the removal of material within the boundary formed by the alignment feature 806 and thus enables the formation of a v-groove in the exposed electrical interconnect layer 803 and substrate 800.

FIG. 10A(b) further shows a perspective drawing of an embodiment of a resulting v-groove 850 after a v-groove patterning step and removal of the mask layer 853. The formation of v-grooves in silicon substrates are known in the art using etchants such as KOH. Dry etching processes using fluorinated chemistry may be used to firstly remove the exposed electrical interconnect layer 803. In other embodiments, other receptacles for mounting an optical fiber such as a trench or a site for mounting a fiber attachment unit may be formed.

Step 410-3b of method 410-3 of FIG. 9 is a placing step in which one or more optical or optoelectrical die or devices are placed onto the interposer PIC structure to form a first interposer PIC assembly having the interposer PIC structure and the placed devices. An example of an optoelectrical die 920 having complementary alignment features 980 to those of the interposer PIC structure 902 is shown in FIG. 10B. Step 410_{die} is a forming step in which an optical or optoelectrical die having alignment features is formed. Step 410_{die} is shown to the side of the flowchart for steps 410-3a-410-3c since the formation of the die can be performed independently. Alignment features 980 on the optoelectrical die provide lateral alignment or constrain movement when a contact is formed with one or more alignment pillars 834 on the interposer. For example, when a contact is formed between a portion of the vertical surface of the alignment aid 980 on the optoelectrical die 920 and a vertical surface of the alignment pillar 834 of the interposer PIC structure 802, movement of the die will be constrained in the direction in which the contact is made. With regard to alignment in the vertical direction, alignment of the horizontal component of the optical axis can be provided with the horizontal component of the optical axis of a feature or device such as a waveguide, for example, upon contact between one or more locations on the horizontal bottom surface of the substrate 960 of the die 960 and one or more locations on the horizontal top surfaces of one or more alignment pillars 834 on the interposer PIC structure 802. Optoelectrical device 920 may be, for example, an edge emitting laser having laser body 946 and edge facet 978. Optical signal 970 is emitted from edge facet 978 at or near the optical axis of the emitting layers of laser 920. The vertical component 908ₗₐₛₑᵣ of the optical axis of the laser device is shown as is the horizontal component 907ₗₐₛₑᵣ of the laser 920.

FIG. 10C(a) shows an interposer PIC structure 802 after placement of a first optoelectrical die 820a into cavity 848 in a first position within the cavity 848 to form interposer PIC assembly 818. Accurate placement of the die 820a, and any other die, is facilitated using fiducial 814 to provide positioning information to an automated pick-and-place apparatus, for example. The downward arrow shows the direction of placement of the die 820a into the cavity 848 in the embodiment. Die 820a is positioned over alignment aids 834.

FIG. 10C(b) shows an interposer PIC structure 802 after placement of a second optoelectrical die 820b into cavity 848. The downward arrow shows the direction of placement of the die 820b into the cavity 848 in the embodiment.

Step 410-3c of method 410-3 of FIG. 9 is an aligning step in which the optical axes of the placed die 820a, 820b are further brought into alignment with the optical axes of the waveguides 844 of the fanout waveguide structure 812. An alignment step may be performed using, for example, a technique in which the surface tension of molten solder in misaligned metal contacts on the optoelectrical die and in the cavity 848 of the interposer PIC structure 802 is such that the die 820a,820b are caused to move closer to the wall of the cavity 848 and thus to bring together the facet (see for example facet 978) of the optoelectrical die 820a,820b and the waveguide facet 852 on the wall of the cavity 848. Alternatively, a mechanical force may be otherwise applied to the die 820a,820b upon heating of the interposer PIC structure to melt the solder connections and allow for movement of the die.

Vertical alignment of the optical axes of the die 820a and the facet 852 of a waveguide 844 of the fanout waveguide structure 812 is facilitated by the formation of surface contact between one or more points on the top of the alignment pillars 834 and the underside of the substrate, for example, of the die 820a. The top surface of the alignment pillars 834 is the top surface of the remaining hard mask 816, for example, if the hard mask has not been removed.

Horizontal alignment of the optical axes of the die 820a and the facet 852 of waveguide 844 of the fanout waveguide structure 812 is facilitated by the formation of a surface contact between one or more points on the vertical surfaces of one or more alignment pillars and one or more edges of the alignment features on the optoelectrical die (see, for example, alignment aid 980 of FIG. 10B.) Horizontal (or lateral) movement may be constrained movement as may be provided in embodiments in which alignment features 980, for example, are positioned between the alignment pillars 834. Alternatively, horizontal movement may be restricted movement in embodiments in which alignment features are positioned to restrict the movement of the die, as, for example, in embodiments in which the movement of the die is restricted upon the formation of a surface contact between a vertical surface on the die and a vertical surface on an alignment pillar 834 or on the wall of the cavity 848

Referring again to FIG. 4, Step 410-4 of method 410 is a singulation step, within which the interposer PIC assemblies 818 having interposer PIC structures and one or more devices are singulated from a wafer in an embodiment in which a multitude of interposer PIC assemblies are formed using wafer level processing. The perspective drawing at the lower portion of FIG. 11 shows a substrate in an embodiment in the form of a wafer. Wafer level processing is a commonly used method of device fabrication in which many individual die are formed on a large substrate that is subsequently diced into individual devices in the singulation process.

Singulated interposer PIC assemblies 818 having mounted devices 820a,820b are shown at the upper portion of FIG. 11. A v-groove 150 is also shown in the perspective drawing at the upper portion of FIG. 11.

Step 410-4 of method 410, shown in FIG. 4, includes an optional mounting step, in which singulated interposer PIC assemblies 818 are mounted onto another substrate for subsequent packaging. Singulated interposer PIC assemblies 818 may be packaged individually, in multiples, or with other devices.

Step 410-5 of method 410, shown in FIG. 4, is a forming step in which a second interposer PIC assembly 818 is formed comprising a multicore fiber 854 and the first interposer PIC 818 having the interposer PIC structure and devices 820. The multicore fiber 854 has a linearly configured arrangement of cores 856. Second PIC assembly that includes the multicore fiber is formed with, for example, the mounting of multicore fiber 854 to the interposer PIC structure 802 of the assembly 818.

FIG. 12A shows interposer PIC assembly 818 comprised of interposer PIC structure 802, mounted devices 820a,820b, and multicore fiber 854 on packaging substrate 876. Multicore fiber 854 is shown in v-groove 850. Lateral alignment aid 806 facilitates the lateral alignment of the linearly configured cores 856 of the multicore fiber 854 with the end facets 852 of the fanout waveguide structure 812 of the interposer PIC structure 802.

FIG. 12B shows another perspective drawing of an embodiment of the interposer PIC assembly 818 mounted or otherwise formed on the packaging substrate 876. Interposer PIC assembly 818 is shown having interposer PIC structure 802, cavity mounted devices 820, and multicore fiber 854. Interposer PIC structure 802 includes fanout waveguide 812.

FIG. 12C shows yet another drawing of an embodiment of the interposer PIC assembly 818 mounted or otherwise formed on the packaging substrate 876 with packaging lid 877 in the embodiment. Multicore fiber 854 is shown in an opening in packaging lid 877 in the embodiment.

In embodiments, the forming step 410-5 may include an alignment step in which the cores of the multicore fiber 854 are brought into rotational alignment with the waveguides 844. In embodiments, rotational alignment can be achieved with the use of rotational stops or flats attached or formed, for example, into one or more of the interposer PIC substrate 802, the fiber cable 854, a collar attached to the fiber cable, a fiber mounting block, a collar attached or coupled to the fiber cable. In other embodiments, rotational alignment can be achieved with the use of an electrical connection to one or more optoelectrical devices mounted on the PIC 618 in which the power delivered to the one or more optoelectrical devices is used to determine a suitable alignment between the cores 856 of the multicore fiber cable 854. In yet other embodiments, one or more channels are provided and coupled to a waveguide 844 that is coupled to an upturned mirror that can then be monitored for optical power delivery to a measurement device positioned over the upturned mirror. Structures and methods of rotational alignment are further described herein.

### Multiple Waveguide Layer PIC Structures and Assemblies

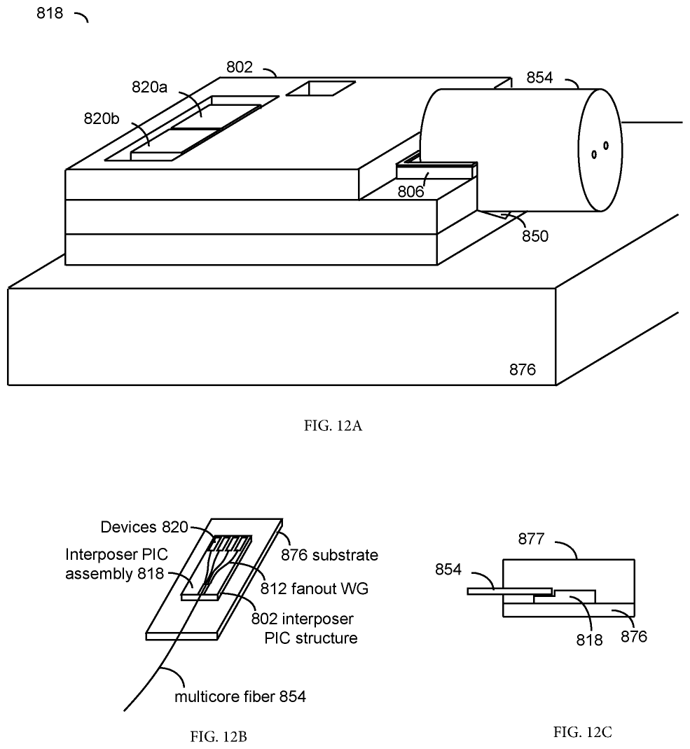

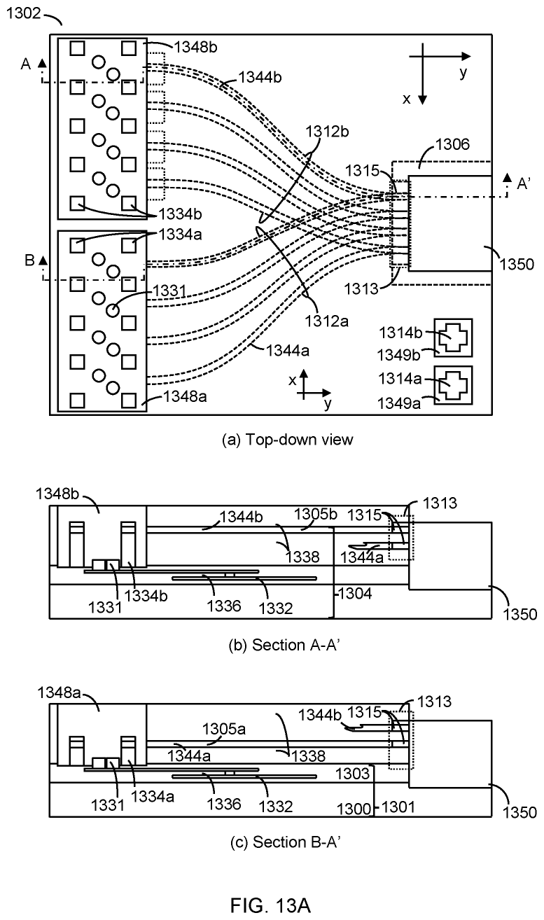

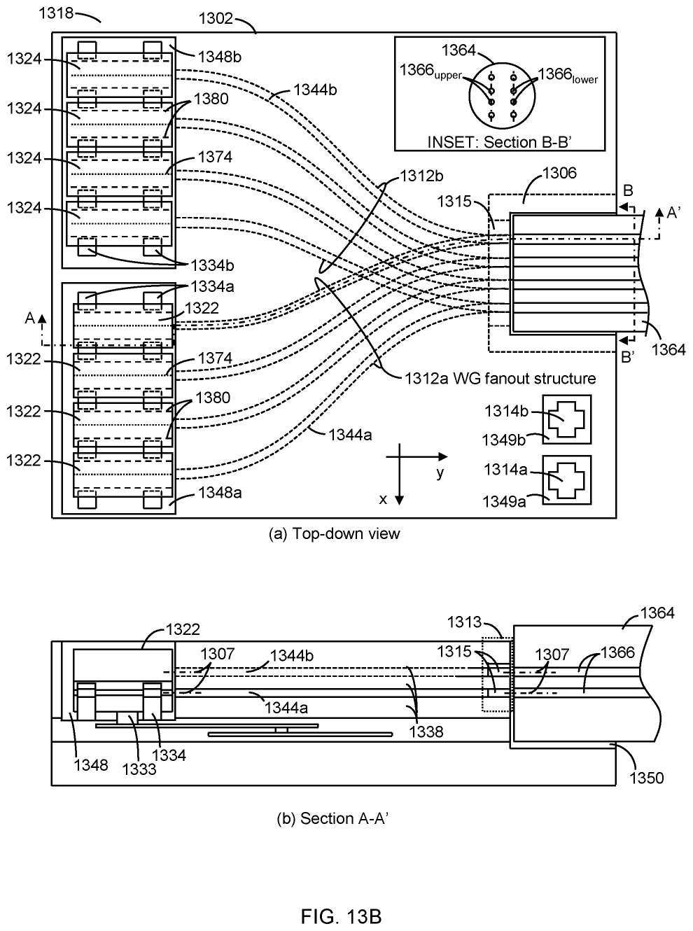

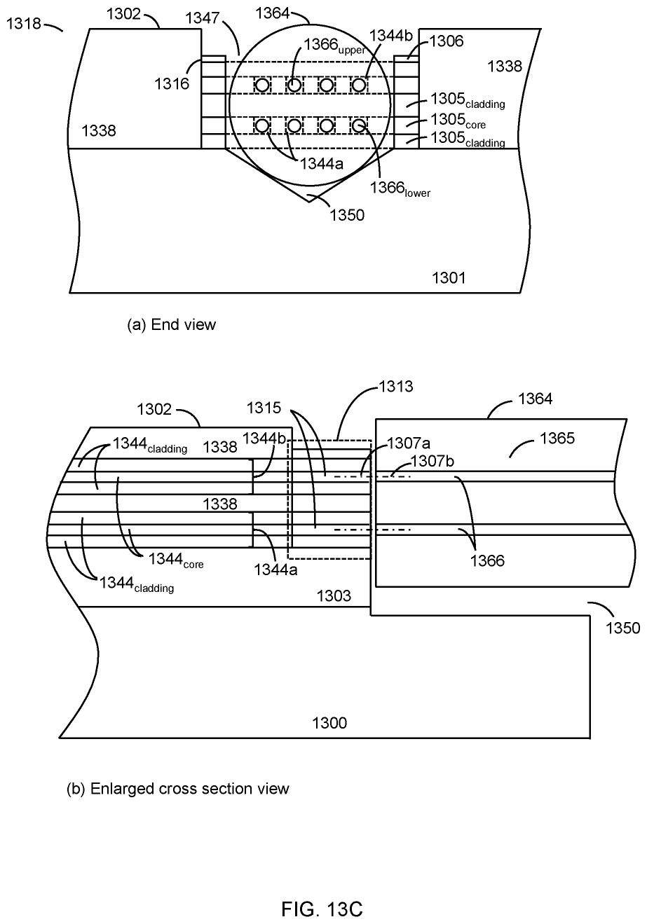

FIGS. 13A(a)-13A(c) show an embodiment of an interposer PIC structure 1302 having multiple fanout waveguide structures 1312a,1312b. In the embodiment, a fanout waveguide structure is provided in each of two planar waveguide layers from which patterned planar waveguides 1344a, 1344b are formed. FIG. 13A(a) shows a top-down view of fanout waveguide structures 1312a,1312b having terminal ends, in the embodiment, at cavities 1348a,1348b and at a wall of v-groove 1350. The termination of the patterned planar waveguides 1344a,1344b at the wall of the v-groove 1350 may be a termination of each waveguide. In the embodiment shown, the waveguides 1344a,1344b firstly terminate in manifold 1313 comprising optional spot size converters 1315.

Section A-A′ in FIG. 13A(b) and Section B-A′ in FIG. 13A(c) show cross section views of the interposer PIC structure 1302 formed from interposer structure 1304 comprising base structure 1301 and patterned planar waveguide layers 1305a, 1305b and, in the embodiment, further comprising the dielectric layers 1338. Section A-A′ includes upper patterned planar waveguide 1344b formed from the planar waveguide layer 1305b and shows terminations of the patterned planar waveguide 1344b at the cavity 1348b and at the manifold 1313 having optional spot size converters 1315 at the v-groove 1350. Alignment pillars 1334b in the cavity are shown formed from a same patterning step from the planar waveguide layer 1305b as the patterned planar waveguide 1344b in the embodiment. Section B-A′ includes lower patterned planar waveguide 1344a formed from the planar waveguide layer 1305a and shows terminations of the patterned planar waveguide 1344a at the cavity 1348a and at the manifold 1313 having optional spot size converters 1315 at the v-groove 1350. Alignment pillars 1334a in the cavity are shown formed from a same patterning step from the planar waveguide layer 1305b as the patterned planar waveguide 1344b in the embodiment.

In Sections A-A′ and B-A′ of FIGS. 13A(b) and 13A(c), respectively, the planar waveguide layers 1305a, 1305b and dielectric layers 1338 are shown on optional electrical interconnect layer 1303 that includes electrical interconnects 1332 and intermetal dielectric layers 1336. Interposer base structure 1301 includes the optional electrical interconnect layer 1303 on substrate 1300. Interposer structure 1304 includes the planar waveguide layers 1305a, 1305b on the base structure 1301 and may include a first dielectric layer 1338 between the lower planar waveguide layer 1344a and the electrical interconnect layer 1303 and may include a second optional dielectric layer 1338 between the lower planar waveguide 1344a and the upper planar waveguide 1344b. A top and inter-waveguide dielectric layer 1338 is shown in Section A-A′ above the upper planar waveguide layer 1305b. In addition to forming a spacer above and below the planar waveguides 1344a, 1344b, the dielectric layer 1338 also fills the spaces between the patterned planar waveguides 1344a, 1344b and may act as a side cladding layer for the patterned waveguides. The dielectric layer 1338 may be a single film, or a combination of layers.

FIG. 13A(a) shows fiducials 1314a, 1314b formed in cavities 1349a, 1349b, respectively. Fiducials 1314a is formed from the same hard mask layer used to pattern the waveguides 1344a of the fanout waveguide structure 1312a, the lateral alignment aid 1306, and the alignment pillars 1334a from planar waveguide layer 1305a. Similarly, fiducial 1314b is formed from the same hard mask layer used to pattern the waveguides 1344b of the fanout waveguide structure 1312b, and the alignment pillars 1334b. In other embodiments, the boundaries of the lateral alignment aid 1306 may alternatively be formed in the upper planar waveguide layer 1305b or in addition to the formation of this alignment aid being formed in the lower planar waveguide layer 1305a.

FIG. 13B shows interposer PIC assembly 1318 having interposer PIC structure 1302, devices 1322,1324, and multicore fiber 1364. The top-down view of the embodiment in FIG. 13A(a) shows a lower fanout waveguide structure 1312a having four patterned planar waveguides 1344a that provide optical coupling from the four optical or optoelectrical devices 1322 mounted in the interposer cavity 1348a to four linearly configured cores 1366 of multicore fiber 1364. The top-down view also shows upper fanout waveguide structure 1312b with four waveguides 1344b that provide optical coupling from the four optical or optoelectrical devices 1324 mounted in interposer cavity 1348b to four other linearly configured cores 1366 of the same multicore fiber 1364. Lateral alignment aid 1306 provides lateral alignment of the linearly configured cores 1366 of the multicore fiber 1364 to the patterned planar waveguides 1344a, 1344b or optional spot size converters 1315 in manifold 1313. Section A-A′ in FIG. 13B(b) shows the lower patterned planar waveguide 1344a and the projection of upper patterned planar waveguide 1344b. The vertical scale of the film structure in Section A-A′ is enlarged for clarity and the vertical scale of the multicore fiber is compressed for clarity. Horizontal components 1307 of the optical axes of the mounted devices 1322 and the patterned planar waveguides 1344a are shown in alignment. Similarly, the horizontal components 1307 of the optical axes of a lower linear arrangement of cores 1366 of a multicore fiber 1364 and the patterned planar waveguides 1344a are also shown in alignment. Horizontal components 1307 of the optical axes of the mounted devices 1324 and the patterned planar waveguides 1344b are also in alignment but, for clarity, the devices are not shown. And the horizontal components 1307 of the optical axes of upper linear arrangement of cores 1366 of a multicore fiber 1364 and the patterned planar waveguides 1344b are also shown in alignment.

In the embodiment shown in FIG. 13B(b), the lower planar waveguide 1344a is shown on a dielectric layer 1338. Dielectric layers 1338 are spacer layers, buffer layers, or cladding layers, for example, that provide spacing and optical signal confinement in addition to that provided by the planar waveguide layer 1305b. Dielectric layers 1338 may be one or more layers of silicon dioxide or silicon oxynitride, for example. A dielectric layer 1338 is shown between the lower patterned planar waveguides 1344a and the upper patterned planar waveguides 1344b that may provide the dimension vertical spacing between the optical axes of the planar waveguide layers and the cores 1366 of the multicore fiber 1364. In some embodiments, this spacer layer 1338 may be a bonded dielectric layer. For some multicore fibers, for example, the separation between the linear rows of cores 1366 in the multicore fiber 1364 can be tens of microns apart and the use of bonded spacers may be more practical than dielectric deposition processes.

In the embodiment of the interposer PIC assembly 1318 in FIGS. 13A and 13B, devices 1322, 1324 are shown mounted on alignment pillars 1334a, 1334b, respectively. In this embodiment, the top of the alignment pillars 1334a on which the devices 1322 are mounted are shown to be at a different height than the alignment pillars 1334b on which the devices 1324 are mounted. In other embodiments, a single alignment pillar height may be used in accordance with the corresponding alignment features formed on the devices 1322, 1324, respectively. Alignment pillars 1334a, 1334b, in the embodiment in FIGS. 13A and 13B, provides vertical alignment with the formation of a surface contact between the tops of the alignment pillars and a portion of a device 1322,1324 mounted on the alignment pillars. Additionally, lateral movement of the devices 1322, 1324 in the x-direction, as referenced in the reference coordinate system in FIGS. 13A and 13B, is constrained within the alignment pillars 1334a, 1334b. The devices 1322,1324, are not constrained, however by the alignment pillars 1334a,1334b in the y-direction. Alignment processes that provide a force to cause movement in the y-direction can thus be used to move the optical axes of the mounted devices 1322,1324 into alignment with the optical axes of the planar waveguide layers 1344a,1344b, respectively. Alternatively, mechanical forces may be otherwise applied to the devices 1322,1324 upon heating of the metal contacts 1331 to cause the optical axes of these devices to be moved into alignment with the optical axes of the patterned planar waveguides 1344a,1344b or optional spot size converters 1315. Heating of the metal contacts 1331 either directly with the application, for example, of energy from a laser or indirectly with the application of heat from an oven or heated substrate may be necessary to enable movement of the devices 1322,1324.

In other embodiments, a second linearly configured multicore fiber may be provided on the PIC 618 with the waveguides 1344a of the lower fanout structure 1312a coupled to the linearly configured cores of one multicore fiber and the waveguides 1344b of the upper fanout waveguide structure 1312b coupled to the linearly configured cores of another multicore fiber.

Section B-B′ in the INSET of FIG. 13B(a) shows a cross section of a multicore fiber 1364, wherein the cores 1366 are configured in linear arrays. In the embodiment, the linearly configured group 1366_{lower} of cores 1366 of the multicore fiber 1364, connected by a common centerline, are in alignment with the lower waveguides 1344a of the fanout waveguide structure 1312a. Similarly, the cores 1366 of the linearly configured group 1366ᵤₚₚₑᵣ of the multicore fiber 1364, also connected by a common centerline, are in alignment with the upper waveguides 1344b of the fanout waveguide structure 1312b. In other embodiments, other numbers of linearly configured cores 1366 may be aligned with the upper and lower waveguides of multilayer fanout waveguide PIC structure 1318.

FIG. 13C(a) shows an end view (looking through fiber into SSC manifold).

FIG. 13C(b) shows an enlarged cross section view of fiber mounting for an embodiment with two waveguide layers on the interposer.

FIG. 13C(a) shows an end view of an embodiment of an interposer PIC assembly 1318 comprised of an interposer PIC structure 1302 and a multicore fiber 1364. Multicore fiber 1364 is shown positioned in a v-groove 1350 formed in interposer base structure 1301. The end view in FIG. 13C(a) shows four cores 1366_{lower} in the lower array of the linearly aligned cores of the eight-core multicore fiber 1364 in alignment with the lower patterned planar waveguides 1344a. The upper four cores 1366ᵤₚₚₑᵣ in the upper array of the linearly aligned portion of the eight-core optical fiber 1364 are shown in alignment with the upper patterned planar waveguides 1344b in the embodiment. Lateral alignment of the cores 1366ᵤₚₚₑᵣ, 1366_{lower} is provided by lateral alignment aid 1306. Lateral alignment aid 1306 is formed from patterned hard mask layer 1316 and one or more of the planar waveguide layers 1305a,1305b and forms a boundary for the formation of v-groove 1350 in the embodiment shown. Planar waveguide layer 1305a in this embodiment is shown on dielectric layer 1338 described herein. Planar waveguide layer 1305a is comprised of a waveguide core for optical signal propagation and cladding layers that provide confinement of the optical signal to the waveguide core further illustrated in FIG. 13C(b). In an embodiment, the waveguide core is a layer of silicon oxynitride and the upper and lower cladding layers are silicon dioxide. In other embodiments, the waveguide core is a layer of silicon oxynitride and the cladding layers are silicon oxynitride with a lower refractive index than that of the core layer. In other embodiments, the waveguide core is a stack of silicon oxynitride layers with a composite refractive index that is greater than the refractive index of the cladding layers. It should be understood that a wide range of planar waveguide structures can be utilized for the formation of the planar waveguide layers 1305a,1305b. In preferred embodiments, the planar waveguide layers 1305a,1305b are structures comprised of a silicon oxynitride core of approximately 2-3 microns in thickness and with top and bottom cladding layers also formed from silicon oxynitride having a lower refractive index than that of the core layer. The thickness of the cladding layers is typically in the range of 2-10 microns. Thicker cladding layers can also be used. Cladding layers of the planar waveguide layers 1305a, 1305b may also be combined with dielectric layer 1338.

Multicore fiber 1364 is supported vertically in v-groove 1350 in the embodiment shown in FIG. 13C(b). In other embodiments, a trench or fiber mounting block may be used.

In the embodiment shown in FIG. 13C(a), the four lower waveguides 1344a of the lower fanout waveguide structure 1312a are shown in alignment with four linearly arranged cores 1366 of the mounted multicore optical fiber 1364 and four upper waveguides 1344b of the upper fanout waveguide structure 1312b are shown in alignment with the other four linearly arranged cores 1366 of the mounted multicore optical fiber 1364.

In embodiments, the lateral spacing between the lower waveguides 1344a in the fanout waveguide structure 1312a is aligned with the lateral spacing of the corresponding cores 1366 of the linearly configured multicore fibers 1364 to which the lower waveguides 1344a are coupled. Additionally, the lateral spacing between the upper waveguides 1344b in the fanout waveguide structure 1312b are aligned with the lateral spacing of the corresponding cores 1366 of the linearly configures multicore fibers 1364 to which the upper waveguides 1344b are coupled.

Lateral alignment aid 1306 is formed using patterned hard mask layer 1316, as described herein. In an embodiment, cavity 1347 may be formed with a photoresist mask patterning of layer 1338 using a selective etch process to remove exposed portions of dielectric layer 1338 without removal of the hard mask layer 1316 on lateral alignment aid 1306. The selective etch process is used to pattern the dielectric layer 1338 to a depth at or near to the interface between the layer 1338 and the substrate 1300, followed by a v-groove forming step.

In other embodiments, the spacing of the optional spot size converters, coupled to the waveguides 1344 in the fanout waveguide structure, are aligned with the spacing of the cores 1366 of the linearly configured multicore fibers 1364.

FIG. 13C(b) shows an enlarged cross section of another embodiment of interposer PIC assembly 1318 comprising a multicore fiber 1364 and a portion of the PIC structure 1302. The enlarged cross section shows the patterned planar waveguides for which the lower waveguide 1344a and upper waveguide 1344b are comprised of upper and lower cladding layers 1344_{cladding}, and core layers 1344_{core}. In an embodiment, the core layer is a layer of silicon oxynitride and the cladding layers are layers are silicon oxynitride with a lower refractive index than that of the core layer. In other embodiments, silicon nitride may be used, silicon oxide may be used, and other materials may be used to form the core layers and the cladding layers. The cores 1344_{core} are shown in substantial alignment with the cores 1366 of the multicore fibers 1364.

FIG. 13C(b) shows alignment of the optical axis 1307b of a core 1366 of the multicore fiber 1364 with the optical axis 1307a of a spot size converter 1315 formed in manifold 1313. The embodiment shows planar waveguide layer 1305 comprising core layer 1305_{core} with top and bottom cladding layers 1305_{cladding}. In the embodiment shown in FIG. 13C(b), the planar waveguide layer is formed on optional underlying dielectric layer 1338 on electrical interconnect layer 1303 on substrate 1300, and another dielectric layer 1338 is shown on the planar waveguide layer 1305. Cladding 1365 of the multicore fiber 1364 is also shown.

Alignment of the optical axes 1307b of the multicore fiber 1364 with the optical axes 1307a of the spot size converters 1315, is facilitated by the formation of the planar waveguides 1344, the waveguide portions of the spot size converters 1315, and the boundaries of the lateral alignment aid 1306 from the same planar waveguide layer 1305, and the use of a single hard mask layer for the patterning of these features.

The optical axes 1307a of the patterned planar waveguides are shown in alignment with the optical axes 1307b of the cores 1366 of the multicore fiber 1364. Alignment of the optical axes of the cores 1364 and the patterned planar waveguides 1344a,1344b can provide improved optical signal transfer between the cores 1366 of the optical fiber 1364 and the patterned planar waveguides 1344a,1344b. Efficient transfer of optical signals between the PIC structure 1318 and the cores 1366 of the multicore fiber 1364 can lead to maintained signal integrity and reduced power loss, among other benefits.

FIG. 14A-14D show other embodiments of multiple waveguide interposer PIC assemblies 1418 for which the cores 1466 of the multicore fiber 1464 are configured in at least two linear arrangements and each of the two linearly aligned portions is aligned with one of the two fanout waveguide structures 1412a, 1412b. In FIG. 14A, an embodiment is shown having a three-core multicore fiber 1464, for example, in which two linearly configured cores 1466 are aligned with two patterned planar waveguides 1444a of the lower waveguide layer and a core 1466 is aligned with a patterned planar waveguide 1444b of the upper planar waveguide layer of the two-waveguide interposer PIC structure 1402.

In FIG. 14B, another embodiment of multiple waveguide interposer PIC assembly 1418 is shown having a seven-core multicore fiber 1464 for which three linearly configured cores 1466 are aligned with the three planar waveguides 1444a of the lower waveguide layer shown, and two cores 1466 are aligned with the two planar waveguides 1444b of the upper planar waveguide layer of the two-waveguide interposer PIC structure 1402.

In FIG. 14C, yet another embodiment of multiple waveguide interposer PIC assembly 1418 is shown having a thirteen-core multicore fiber 1464 for which four linearly configured cores 1466 are aligned with four planar waveguides 1444a of the lower waveguide layer shown, and four cores 1466 are aligned with four planar waveguides 1444b of an upper planar waveguide layer of the two-waveguide interposer PIC structure 1402.

In FIG. 14D, yet another embodiment of multiple waveguide interposer PIC assembly 1418 is shown having a nineteen-core multicore fiber 1464 for which four linearly configured cores 1466 are aligned with four planar waveguides 1444a of the lower waveguide layer shown, and four cores 1466 are aligned with four planar waveguides 1444b of an upper planar waveguide layer of the two-waveguide interposer PIC structure 1402.

Although all of the cores 1466 of multicore fiber 1464 may be aligned with waveguides, as in the case of the embodiment shown in FIG. 14A, not all of the cores 1466 need be utilized. For the embodiment shown in FIG. 14A, for example, all of the cores 1466 in the three-core multicore fiber 1464 are aligned with waveguides on the interposer PIC assembly 1418. In FIGS. 14B-14D, however, not all of the cores are aligned with waveguides on the interposer PIC structure 1402. In the embodiment in FIG. 14B, for example, two cores are shown not in alignment with waveguides 1444a,144b. In some embodiments, the cores 1466 that are not aligned with waveguides on the interposer PIC structure 1402 may be used for other purposes other than carrying optical signals to and from the interposer PIC structure 1402. In an embodiment, for example, the cores 1466 can be used for rotational or other alignment of the cores 1466 with the waveguides 1444a, 1444b. In the embodiment shown in FIG. 14C, a core 1466 at the top and bottom, and the three cores in the center of the thirteen-core fiber 1464 are not aligned with waveguides of the PIC structure 1418. These unused cores may be utilized, in some embodiments, for rotational alignment. It should be noted that the alignment of a core 1466 with a waveguide 1444a,144b may also be utilized for rotational alignment, as further described herein.

In the embodiments shown in FIGS. 14B-14D, the quantity and configuration of the cores 1466 of the multicore fibers 1464 differ than the quantity and configuration of waveguides 1444a, 1444b of the fanout waveguide structure of the interposer PIC structure 1402. In other embodiments, the cores 1466 of the multicore fiber 1464 can have the same quantity and configuration as the waveguides 1444a, 1444b of the interposer PIC structure 1402.

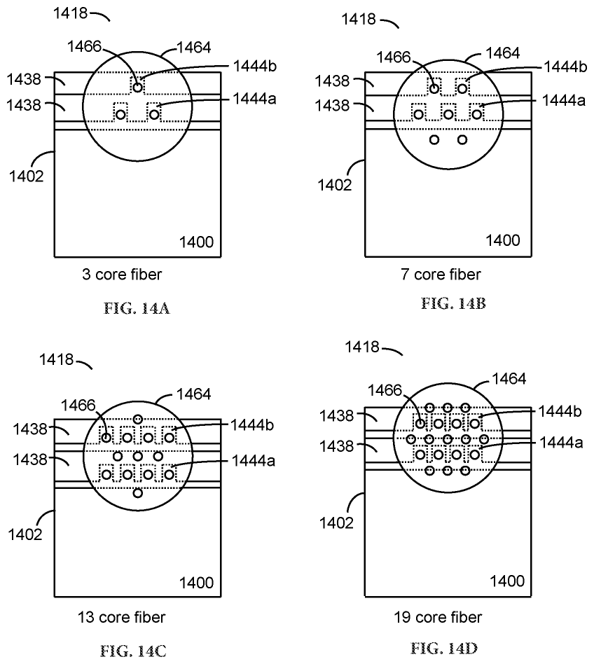

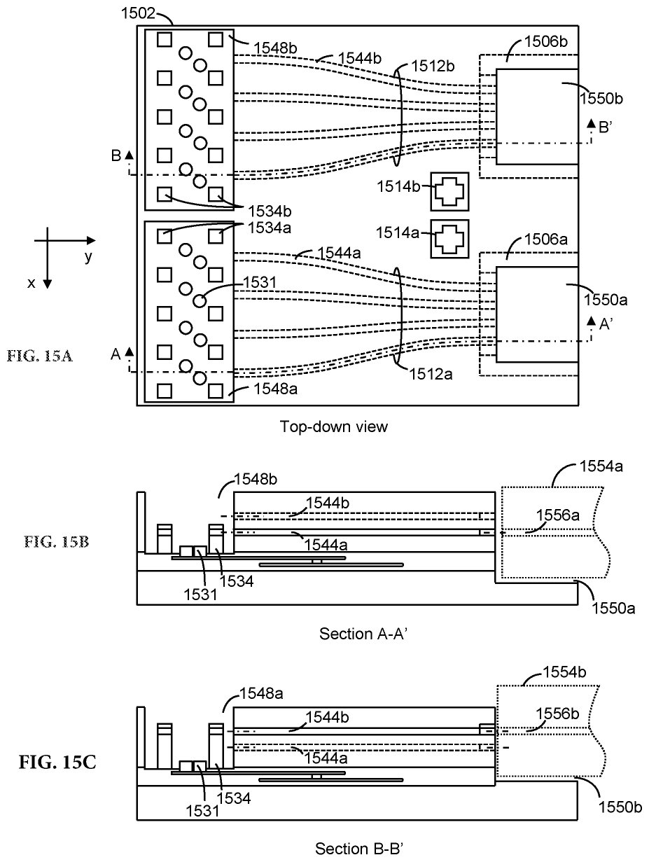

FIGS. 15A-15C show an embodiment of interposer PIC structure 1502 having two waveguide layers from which the patterned planar waveguide layers 1544a, 1544b are formed. The top-down view of FIG. 15A shows a lower fanout waveguide structure 1512a with a terminal end at the wall of cavity 1548a and another terminal end at v-groove 1550a. Cavity 1548a shows alignment pillars 1534a and electrical contacts 1531. V-groove boundary 1506a, fiducial 1514a, planar waveguides 1544a, and alignment pillars 1534a are formed from a same patterned hard mask layer to provide alignment within the resolution of the lithographic approach used to pattern the hard mask layer, and within the resolution of the etch or other patterning processes used to pattern the hard mask and the underlying layers used in the formation of these structures.

Similarly, the top-down view of FIG. 15A also shows an upper fanout waveguide structure 1512b with a terminal end at the wall of cavity 1548b and another terminal end at v-groove 1550b. Cavity 1548b shows alignment pillars 1534a and electrical contacts 1531. V-groove boundary 1506b, fiducial 1514b, planar waveguides 1544b, and alignment pillars 1534b are formed from a same patterned hard mask layer to provide alignment within the resolution of the lithographic approach used to pattern the hard mask layer, and within the resolution of the etch or other patterning processes used to pattern the hard mask and the underlying layers used in the formation of these structures.

The embodiment of the interposer PIC structure 1502 shows two fanout waveguide structures 1512a,1512b that are each coupled to a v-groove 1550a, 1550b, respectively. In this embodiment, either multicore fiber 1554 having a single array of linearly configured cores or multicore fiber having multiple linearly configured arrays of cores may be mounted or otherwise attached to interposer PIC structure 1502 to form an interposer PIC assembly. V-grooves in the embodiment, are shown at different depths to accommodate the different elevations of the optical axes of the patterned planar waveguides. In other embodiments, the v-groove depths may be the same, and the difference in elevation of the optical axes of the patterned planar waveguides may be aligned with different linearly configured arrays of cores in the multicore fiber to enable the cores of the fiber to be aligned with the patterned planar waveguides. In another embodiment for which the v-grooves 1550a,1550b are formed at the same depth, two different multicore fibers are mounted or otherwise formed in the v-grooves 1550a,1550b to accommodate the differences in height between the patterned planar waveguides. In this embodiment, a linearly configured array from one multicore fiber may align with the patterned planar waveguides of a fanout waveguide, and a linearly configured array from another multicore fiber with a different configuration of cores may align with the patterned planar waveguides of the other fanout waveguide.

In Section A-A′ from FIG. 15A, shown in FIG. 15B, lower patterned planar waveguide 1544a is shown with a projection of upper patterned planar waveguide 1544b. FIG. 15B shows an outline of a multicore fiber 1556a in which the cores 1556a are in alignment with the planar waveguide layer 1544a. The fiber 1556a is mounted in the v-groove 1550a of the interposer PIC structure 1502.

Similarly, in Section B-B′ from FIG. 15A, shown in FIG. 15C, upper patterned planar waveguide 1544b is shown with a projection of lower patterned planar waveguide 1544a. FIG. 15B shows an outline of a multicore fiber 1556b in which the cores 1556b are in alignment with the planar waveguide layer 1544b. The fiber 1556b is mounted in the v-groove 1550b of the interposer PIC structure 1502.

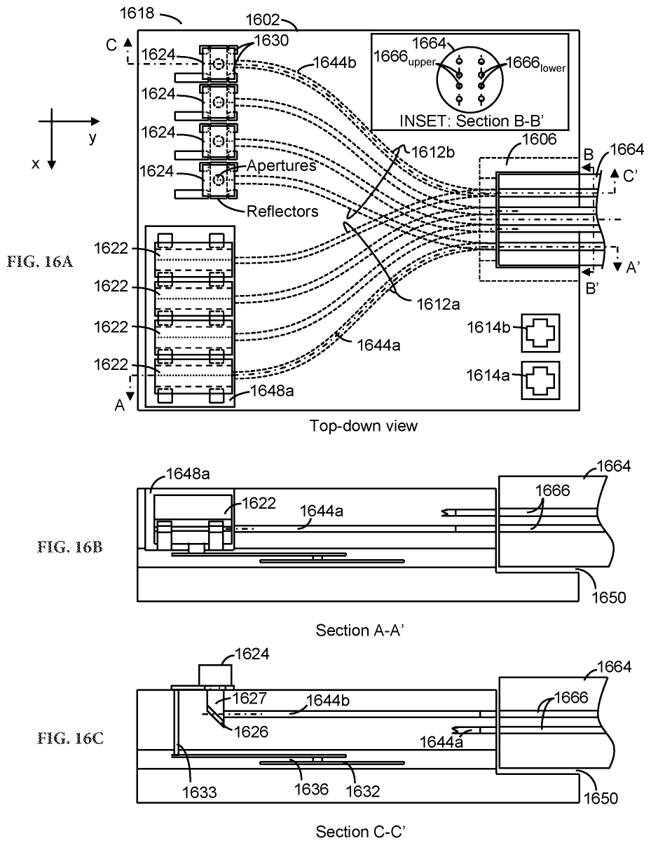

FIGS. 16A-16C show an embodiment of interposer PIC assembly 1618 comprising interposer PIC structure 1602, mounted devices 1622, 1624, and multicore waveguide 1664.

The interposer PIC structure 1602 has two fanout waveguide structures 1612a, 1612b formed from patterned planar waveguides 1644a,1644b, respectively, as shown in the top-down view of FIG. 16A. In Section A-A′ shown in FIG. 16B, the lower patterned planar waveguides 1644a have a terminal end at the wall of cavity 1648a, and another terminal end at the wall of the v-groove 1650. Cavity mounted devices 1622 are shown on the alignment pillars in cavity 1648a. In Section C-C′, the upper planar waveguides 1644b have a terminal end at the wall of reflector cavity 1627 and another terminal end at the wall of a v-groove 1650.

In the embodiment shown in FIGS. 16A-16C, multicore fiber 1664 has multiple linearly configured arrays of cores 1666 as shown in the INSET in FIG. 16C. The cores 1666_{lower} are in alignment with the patterned planar waveguides 1644a. The cores 1666ᵤₚₚₑᵣ are in alignment with the patterned planar waveguides 1644b.

The embodiment shown in FIG. 16 shows a configuration in which surface mounted devices 1624 are coupled to a fanout waveguide, namely fanout waveguide 1612b. In other embodiments, the surface mounted devices may be coupled to the lower fanout waveguide 1612a. The embodiment in FIG. 16 also shows a configuration having a reflector 1626 to couple optical signals to or from the upper patterned planar waveguide 1644b to surface mounted device 1624. In embodiments, surface mounted device 1624 may be a receiving device, such as a photodiode. In other embodiments, surface mounted device 1624 may be an emitting device, such as a laser.

### Alignment Structures and Methods

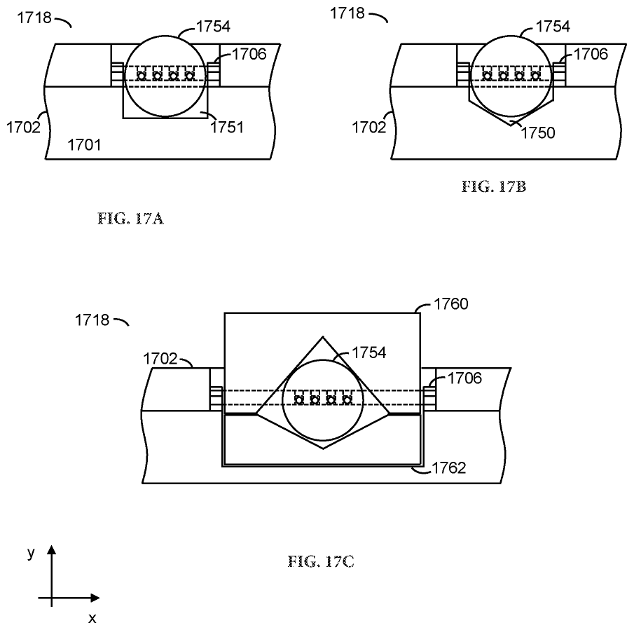

FIGS. 17A-17C show embodiments of interposer PIC structures 1702 with various configurations for the mounting of a multicore fiber 1754 to form interposer PIC assembly 1718.

FIG. 17A shows an embodiment with MCF in a trench.

FIG. 17B shows an embodiment with MCF in a v-groove.

FIG. 17C shows an embodiment with MCF in a Fiber attach unit.

FIG. 17A shows an embodiment of an interposer PIC structure 1702 having multicore fiber 1754 mounted in trench 1751. Lateral alignment aid 1706 provides lateral alignment of the cores of the multicore fiber 1754 with the patterned planar waveguides of the fanout waveguide of the interposer PIC structure 1702. Trench 1751, in the embodiment, is shown with a flat bottom. Trenches with other shaped bottoms may also be used.

FIG. 17B shows an embodiment of an interposer PIC structure 1702 having multicore fiber 1754 mounted in v-groove 1750. Lateral alignment aid 1706 provides lateral alignment of the cores of the multicore fiber 1754 with the patterned planar waveguides of the fanout waveguide of the interposer PIC structure 1702. V-groove 1750, in the embodiment, is shown with a “v”-shaped bottom.

FIG. 17C shows an embodiment of an interposer PIC structure 1702 having multicore fiber 1754 mounted in a fiber attachment unit 1760. Lateral alignment aid 1706 provides lateral alignment of the cores of the multicore fiber 1754 mounted in the fiber attachment unit with the patterned planar waveguides of the fanout waveguide of the interposer PIC structure 1702. The fiber attachment unit 1760 is shown, in the embodiment, in fiber attachment unit mounting site 1762.

In each of the embodiments shown in FIGS. 17A-17C, lateral alignment aid 1706 provides lateral alignment of the multicore fiber in the ‘+x’ and ‘−x’ directions (as referenced in the reference coordinates shown). In the following paragraphs, embodiments of interposer PIC structures and interposer PIC assemblies with provisions for radial alignment are described.

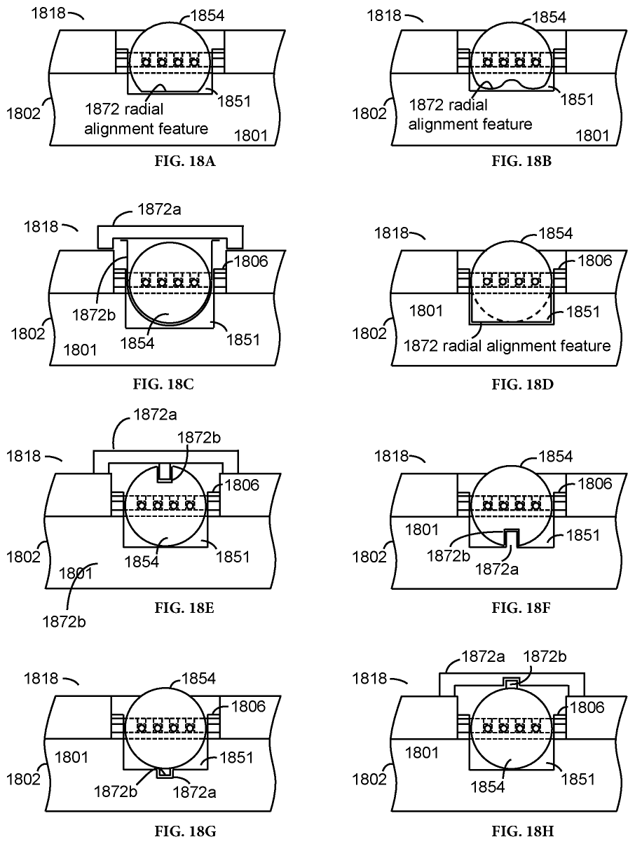

FIGS. 18A-18H show embodiments of interposer PIC structures 1802 and assemblies 1818 that enable the use of passive radial alignment. In these embodiments, radial alignment features are formed on the interposer PIC structure 1802 or on the multicore fiber 1854 of the interposer PIC assembly 1818.

FIG. 18A shows multicore fiber 1854 having a radial alignment feature 1872. A flat surface has been formed on the cladding of the multicore fiber 1854 and the flat is shown in contact with the bottom surface of trench 1851 formed in the interposer base structure 1801 of the interposer PIC structure 1802. The radial alignment feature 1872 shown in FIG. 18A may be formed by grinding, machining, cutting, or other means that enables the formation of a flat surface in the cladding or jacket of the multicore fiber 1854.

FIG. 18B shows another multicore fiber 1854 having a radial alignment feature 1872. A flattened surface has been formed in the cladding of the multicore fiber 1854 and the approximately flattened surface is shown in contact with the bottom surface of trench 1851 formed in the interposer base structure 1801 of the interposer PIC structure 1802. The radial alignment feature 1872 shown in FIG. 18A may be formed, for example, during the spooling process in the manufacturing of the multicore fiber 1854. The approximately flattened surface of the multicore fiber shown in FIG. 18B may also be formed by grinding, machining, cutting, or other means that enables the formation of a flattened surface and that enables at least two points of contact in the cladding or jacket of the multicore fiber 1854 to be made with the bottom surface of trench 1851 formed in the interposer base structure 1801 of the interposer PIC structure 1802.

FIG. 18C shows another multicore fiber 1854 having a two-piece radial alignment feature comprising radial alignment feature 1872a and radial alignment feature 1872b. Radial alignment feature 1872a, in the embodiment shown, is a workpiece that contacts the upper surface of the interposer PIC structure 1802 that is secured to the top surface to prevent rotation. Alignment feature 1872 may be affixed to the top surface of interposer PIC structure 1802 with epoxy or an adhesive material, or may be mechanically secured, for example with a screw or other connecting means. The radial alignment feature 1872b is secured to the multicore fiber 1854 and to the radial alignment feature 1872a to provide radial alignment of the fiber 1854.

FIG. 18D shows multicore fiber 1854 having a radial alignment feature 1872. A flat surface has been formed on the multicore fiber 1854 using a flat forming material that is added to the multicore fiber 1854 and the flat forming material is shown in contact with the bottom surface of trench 1851 formed in the interposer base structure 1801 of the interposer PIC structure 1802. The radial alignment feature 1872 shown in FIG. 18D may be formed by one or more of potting, 3D printing, extruding, shaping, or other additive process or combination of additive processes. The radial alignment feature 1872 of FIG. 18D may be formed by a first step of one or more of potting, 3D printing, extruding, or other additive process or combination of additive processes and a second step of shaping, grinding, machining, cutting, or other subtractive means that enables the formation of a flat surface onto the cladding, jacket, or other portion of the multicore fiber 1854.

FIG. 18E shows another multicore fiber 1854 having a radial alignment feature comprising radial alignment feature 1872a and radial alignment feature 1872b. Radial alignment feature 1872a, in the embodiment shown, is a workpiece that contacts the upper surface of the interposer PIC structure 1802 that is secured to the top surface to prevent rotation. Radial alignment feature 1872a has a protrusion, as shown, that aligns with radial alignment feature 1872b, a notch, formed in the jacket or cladding of the multicore fiber 1854. Alignment feature 1872a may be affixed to the top surface of interposer PIC structure 1802 with epoxy or an adhesive material, or may be mechanically secured, for example with a screw or other connecting means. The radial alignment feature 1872b of FIG. 18E may be formed by shaping, grinding, machining, cutting, or other subtractive means that enables the formation of a notch in the cladding or jacket of the multicore fiber 1854 that is receptive to the protrusion on radial alignment feature 1872a to provide radial alignment of the multicore fiber 1854.

Alternatively, a protrusion may be formed in the bottom of trench 1851 as shown in FIG. 18F. A protrusion may be formed in the trench 1851 using masking and etch patterning processes, for example. The notch in the multicore fiber 1854 can be formed as in the description of the formation of the notch shown in FIG. 18E.

FIG. 18G shows another multicore fiber 1854 having a radial alignment feature comprising radial alignment feature 1872a and radial alignment feature 1872b. Radial alignment feature 1872a, in the embodiment shown, is a notch formed in the bottom a trench 1851 using, for example, masking and etch patterning processes. Radial alignment feature 1872b is a protrusion formed on multicore fiber 1854 that aligns, as shown, with the radial alignment feature 1872a formed in the trench 1851 of interposer PIC structure 1802. The radial alignment feature 1872b of FIG. 18G may be formed, for example, by one or more of potting, 3D printing, extruding, shaping, or other additive process or combination of additive processes. The radial alignment feature 1872b of FIG. 18E may also be formed by a first step of one or more of potting, 3D printing, extruding, or other additive process or combination of additive processes and a second step of shaping, grinding, machining, cutting, or other subtractive means that enables the formation of a protrusion onto the cladding, jacket, or other portion of the multicore fiber 1854.

FIG. 18H shows another multicore fiber 1854 having a radial alignment feature comprising radial alignment feature 1872a and radial alignment feature 1872b. Radial alignment feature 1872a, in the embodiment shown, is a workpiece that contacts the top surface of the interposer PIC structure 1802 and that is secured to the top surface to prevent rotation. Radial alignment feature 1872a has a notch, as shown, that aligns with radial alignment feature 1872b, a protrusion, formed in or on the jacket or cladding of the multicore fiber 1854. Alignment feature 1872a may be affixed to the top surface of interposer PIC structure 1802 with epoxy or an adhesive material, or may be mechanically secured, for example with a screw or other connecting means. The radial alignment feature 1872b of FIG. 18E may be formed by an additive process. The radial alignment feature 1872b of FIG. 18E may also be formed by a combination of additive and subtractive processes that enables the formation of a protrusion in the cladding or jacket of the multicore fiber 1854 that can be aligned with the notch on radial alignment feature 1872a to provide radial alignment of the multicore fiber 1854.

Configurations of radial alignment features for multicore fibers 1854 in embodiments of interposer PIC structures 1802 have been disclosed. Other configurations may be derived from the features described. In other configurations, for example, notches may be formed in place of protrusions on a multicore fiber, for example, and protrusions may be formed in place of notches on the complementary alignment in the trench or workpiece.

In other configurations, elements described may be combined in other ways to provide the same benefit of radial alignment.

And in yet other configurations, additive processes may be used to provide shaped features that are formed in or on the multicore fibers that enable the subsequent alignment of the cores to the patterned planar waveguides of the fanout waveguide structure. A ball with a flat may be formed on the multicore fiber, for example, that is aligned with a conforming shape on the interposer PIC structure 1802 to provide alignment of the fiber cores with the patterned planar waveguides of a fanout waveguide.

And in yet other configurations, the radial alignment features that form a contact with the top surface of the interposer PIC structure may alternatively form a contact with the back surface of the interposer PIC structure. And in yet other configurations, the radial alignment features that form a contact with the top surface of the interposer PIC structure may alternatively form a contact with another surface, such as the surface of a cavity or trench or other feature formed in the interposer PIC structure. Radial alignment features may be also be configured to form a contact with a surface that is not horizontal to provide the radial alignment.

The configurations described herein for the radial alignment features 1872, 1872a,1872b may be secured in place with one or more of an epoxy, another adhesive material, and a mechanical means of securing such as, for example, a screw or other mechanical means.

The configurations shown in FIG. 18 for the radial alignment features that provide radial alignment for the multicore fibers described herein, may also be used in configurations with v-grooves for mounting of the multicore fibers 1854.

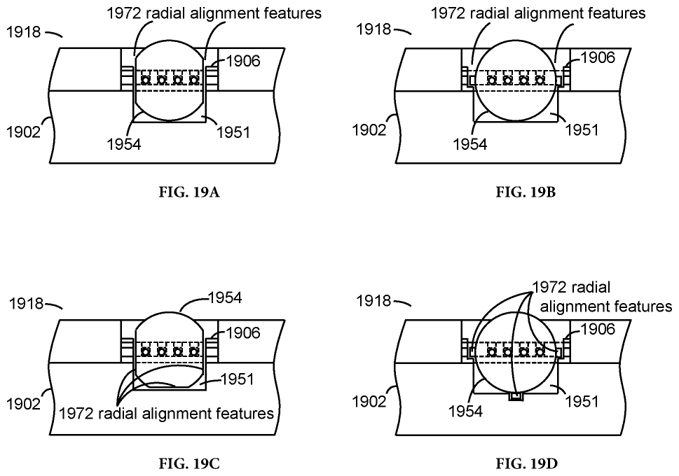

FIGS. 19A-19D show other configurations that enable passive radial alignment for embodiments of interposer PIC assemblies 1918 that include multicore fibers 1954 having linearly configured arrays of cores. As is the case with the configurations shown in FIG. 18, the passive radial alignment enabled with the radial alignment features shown in FIG. 19 are used in embodiments, in conjunction with the lateral alignment features for the multicore fiber (see lateral alignment feature 106, for example).

FIG. 19A shows a multicore fiber 1954 having an alignment feature 1972 formed at multiple locations on one or more of the cladding, jacket, and cladding and jacket of the multicore fiber. The alignment features 1972, in the configuration shown, are formed on opposite sides of the multicore fiber 1954 in the embodiment and provide radial alignment of the cores with the patterned planar waveguides of the interposer PIC structure 1902.

The flat surfaces of the multicore fiber 1954 are shown to be aligned with the flat vertical sidewalls of the trench 1951 on the interposer PIC structure 1902. The flat surfaces formed on the multicore fibers may be formed on the cladding of the multicore fiber 1954. The radial alignment features 1972 shown in FIG. 19A may be formed by grinding, machining, cutting, or other means that enables the formation of a flat surface in the cladding or jacket of the multicore fiber 1954. Flats or approximate flats, as shown for example in FIG. 18B, may be formed during the spooling of the fiber in the manufacturing of the fiber prior to cooling.

FIG. 19B shows another multicore fiber 1954 having a radial alignment feature comprising radial alignment features 1972 formed at multiple locations on one or more of the cladding, jacket, and both cladding and jacket of the multicore fiber. Radial alignment features 1872, in the embodiment shown, are formed on opposite sides of the multicore fiber 1954 and provide radial alignment of the cores with the patterned planar waveguides of the interposer PIC structure 1902.

The protrusions formed on the multicore fiber 1954 are shown to be aligned with notches formed in the vertical sidewalls of the trench 1951 on the interposer PIC structure 1902. The protrusions may be formed on the cladding of the multicore fiber 1954 using additive processes and using combinations of additive and subtractive processes as described herein. The notches formed in the sidewall can be formed by providing a complementary pattern to that of the protrusion in the hard mask pattern used in the formation of the lateral alignment aid 1906.

FIG. 19C shows a multicore fiber 1954 having an alignment feature 1972 formed at multiple locations on one or more of the cladding, jacket, and cladding and jacket of the multicore fiber. The alignment features 1972, in the configuration shown, are formed on three sides of the multicore fiber 1954 in the embodiment and provide radial alignment of the cores with the patterned planar waveguides of the interposer PIC structure 1902.

The flat surfaces of the multicore fiber 1954 are shown to be aligned with the flat vertical sidewalls of the trench 1951 and the flat bottom of the trench 1951 on the interposer PIC structure 1902. The flat surfaces formed on the multicore fibers may be formed on the cladding of the multicore fiber 1954. The flat surfaces formed on the multicore fibers may also be formed in the jacket of the multicore fiber. The radial alignment features 1972 shown in FIG. 19C may be formed by grinding, machining, cutting, or other means that enables the formation of a flat surface in the cladding or jacket of the multicore fiber 1954. Flats or approximate flats, as shown for example in FIG. 18B, may be formed during the spooling of the fiber in the manufacturing of the fiber prior to cooling. In an embodiment, the opposite flats that align to the sides of the trenches may be formed using a subtractive process such as grinding and the flat that aligns to the bottom of the trench may be formed during the spooling process in the manufacturing of the multicore fiber.

FIG. 19D shows another multicore fiber 1954 having a radial alignment feature comprising radial alignment features 1972 formed at multiple locations on one or more of the cladding, jacket, and both cladding and jacket of the multicore fiber. Radial alignment features 1972, in the embodiment shown, are formed on three sides of the multicore fiber 1954 and provide radial alignment of the cores with the patterned planar waveguides of the interposer PIC structure 1902.

The protrusions formed on the multicore fiber 1954 are shown to be aligned with notches formed in the vertical sidewalls of the trench 1951 and on the bottom of the trench 1951 as shown in FIG. 19D for the interposer PIC structure 1902. The protrusions may be formed on the cladding of the multicore fiber 1954 using additive processes and using combinations of additive and subtractive processes as described herein. The notches formed in the sidewall can be formed by providing a complementary pattern to that of the protrusion in the hard mask pattern used in the formation of the lateral alignment aid 1906. The notch formed in the trench can be formed, for example, using masking and etch patterning processes. Other methods may also be used.

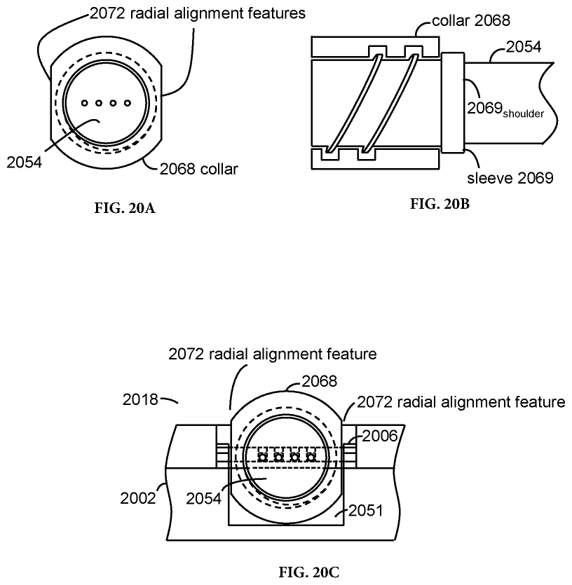

FIGS. 20A-20C shows another multicore fiber 2054 having a radial alignment feature comprising radial alignment features 1972 formed at one or multiple locations on a collar 2068 that can be fitted or otherwise formed over a sleeve formed on the multicore fiber 2054. Radial alignment features 2072, in the embodiment shown in FIG. 20A, are formed on opposite sides of collar 2068 on the multicore fiber 2054 and provide radial alignment of the cores with the patterned planar waveguides of the interposer PIC structure 2002 in assembly 2018. A side view of a portion of multicore fiber 2054 is shown in FIG. 20B with a cross section of the collar 2068 and sleeve 2069. In the embodiment shown, the sleeve 2069 is formed on the multicore fiber 2054 such that a shoulder 2069_{shoulder} on the sleeve 2069 provides a radial stop for the collar 2068 and thus provides radial alignment of the cores of the multicore fiber 2054 with the patterned planar waveguides of the interposer PIC structure 2002. FIG. 20C shows the embodiment of the multicore fiber 2054 from FIG. 20A in trench 2051 of the interposer PIC structure 2002. The alignment features 2072 on the opposite sides of the collar 2068 in close proximity to the vertical sidewalls of the trench 2051 enable the alignment of the cores of the multicore fiber with the patterned planar waveguides in the fanout waveguide structure on the interposer PIC structure 2002. The trench 2051 may be formed, for example, using the patterned hard mask of the alignment feature 2006 and suitable etch patterning steps. The flats 2072 formed on the collar 2068 may be formed using one or more of a grinding, cutting, polishing, and other form of subtractive processes to remove material to form a flat. Alternatively, the flats can be formed using a molding, shaping, or extruding process to form the flats on the collar 2068. Other methods and combinations of methods may also be used.

In another embodiment, one or more flats may be formed on the collar 2068 to provide one or more radial alignment features 1272. In an embodiment, a single flat is provided that aligns with the bottom of the trench 2051. In another embodiment, a single flat is provided that aligns with a sidewall of the trench 2051. In other embodiments, three flats are provided that align with the bottom of the trench 2051 and the vertical sidewalls of the trench 2051. In some embodiments, more than three flats may be formed on the collar 2068 and aligned with the trench 2051.

In yet other embodiments, the interposer PIC structure 2002 is formed with a v-groove and flats formed on the collar 2068 are made to conform to the shape of the v-groove to enable the alignment of the cores of the multicore fiber with the patterned planar waveguides of the fanout structure on the interposer PIC structure 2002.

And in yet other embodiments, the interposer PIC structure 2002 is formed with a mounting site for a fiber attachment unit and the alignment features formed on the collar 2068 conform with the fiber attachment unit to provide alignment of the cores of the multicore fiber with the patterned planar waveguides of the fanout waveguide structure of the interposer PIC structure 2002.

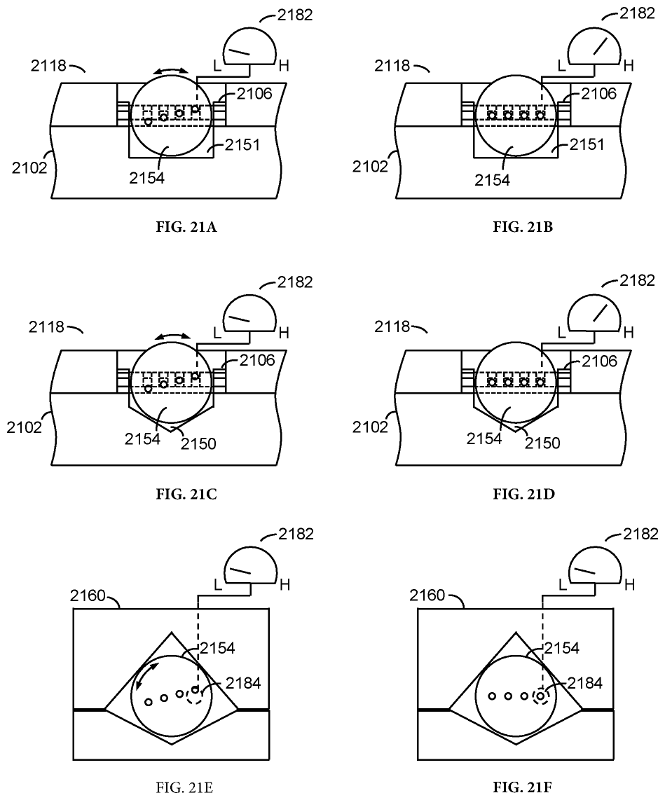

FIG. 21A-21F show embodiments of methods of active alignment for aligning the multiple cores of the multicore fiber 2154 with the patterned planar waveguides of the fanout waveguide structure on the interposer PIC structure 2102. FIG. 21A and 21B show an embodiment having multicore fiber 2154 positioned in trench 2151. One of the four cores of the multicore fiber 2154 and the patterned planar waveguides are coupled to a measurement apparatus 2182.

In an embodiment, an optical signal is provided to a core of the multicore fiber 2154. In a misaligned state, as shown in FIG. 21A, a weak or non-existent signal will be measured at the measurement apparatus 2182. As the multicore fiber 2154 is rotated (as shown by the arc with double arrows to indicate directions of rotation), the signal strength measured at the measurement apparatus will reach a maximum at the rotational orientation at which the core having the optical signal is in alignment with the patterned planar waveguide to which the measurement apparatus is coupled.

In another embodiment, an optical signal is provided from an emitting device to a patterned planar waveguide on the interposer PIC structure 2102 and subsequently from the patterned planar waveguide to a core of the multicore fiber 2154. In a misaligned state, as shown in FIG. 21A, a weak or non-existent signal will be measured at a measurement apparatus 2182 coupled to the core of the multicore fiber 2154 corresponding with the patterned planar waveguide that is carrying the optical signal from the emitting device. As the multicore fiber 2154 is rotated, the signal strength measured at the measurement apparatus will reach a maximum at a rotational orientation in which the core having the optical signal is in alignment with the patterned planar waveguide from which the optical signal from the emitting device is provided.

FIGS. 21C and 21D show similar misaligned and aligned configurations, respectively, as FIGS. 21A and 21B with an embodiment in which the multicore fibers 2154 are positioned in v-grooves on the interposer PIC structures 2102.

FIGS. 21E and 21F show similar misaligned and aligned configurations, respectively, as FIGS. 21A and 21B with an embodiment in which the multicore fibers 2154 are positioned in fiber attachment units that, after alignment, are mounted onto fiber attachment mounting sites formed on the interposer PIC structures 2102. (See for example, fiber attachment mounting site 1762 in FIG. 17.)

Measurement apparatus 2182 in FIGS. 21A-21F may be a discrete device such as a photodiode, or may be a measurement apparatus such as a spectrometer or electronic optical detection system. Measurement apparatus 2182 may be mounted or otherwise formed on the interposer PIC structure or may be otherwise coupled to the interposer PIC structure.

Emitting device may be one or more of a discrete laser, LED, light bulb, and other emitting device or combination of discrete devices. Emitting device may be mounted or otherwise formed on the interposer PIC structure or may be otherwise coupled to the interposer PIC structure.

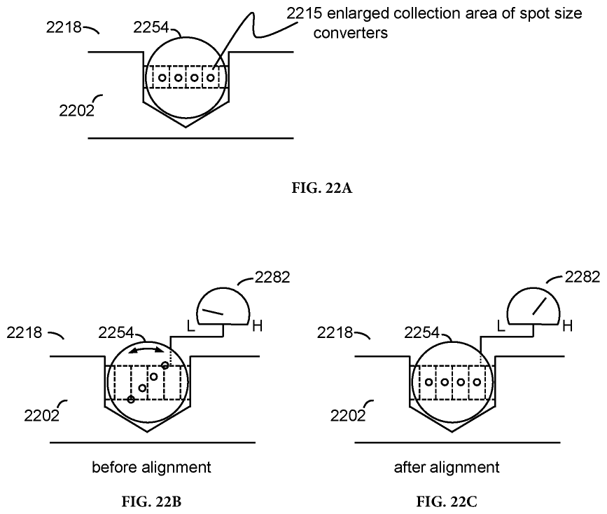

FIG. 22A- 22C show embodiments of methods of active alignment for aligning multiple cores of multicore fiber 2254 with the patterned planar waveguides of the fanout waveguide structure on the interposer PIC structure 2202. FIG. 22A shows an interposer PIC assembly 2218 for which the collection area of the patterned planar waveguides of the fanout waveguides on the interposer PIC structure is enlarged to facilitate an active alignment process. The use of spot size converters 2215 at the terminal ends of the patterned planar waveguide can increase the coupling efficiency for optical signals being transferred from the cores of the multicore fiber 2254 to the spot size converters 2215 and subsequently to the patterned planar waveguides of a fanout waveguide structure. In the embodiment of the interposer PIC structure 2202, a v-groove is shown for mounting a multicore fiber. In other embodiments, a trench or fiber attachment unit may be used to mount a multicore fiber to the interposer PIC structure 2202.

In an embodiment, an optical signal is provided to a core of the multicore fiber 2254. One of the four cores of the multicore fiber 2154 and the patterned planar waveguides are coupled to a measurement apparatus 2182.

In a misaligned state, as shown in FIG. 22B, a weak or non-existent signal will be measured at the measurement apparatus 2282. As the multicore fiber 2254 is rotated (as shown by the arc with double arrows to indicate directions of rotation), the signal strength measured at the measurement apparatus will reach a maximum at the rotational orientation for which the core having the optical signal is in alignment with the patterned planar waveguide to which the measurement apparatus is coupled as shown in FIG. 22C. Multicore fibers 2254 may be secured in place with one or more of an epoxy, another adhesive material, and a mechanical means of holding the rotational alignment of the multicore fiber in alignment with the patterned planar waveguides of the fanout waveguide structure.

In some embodiments, more than one core may be coupled to the measurement apparatus.

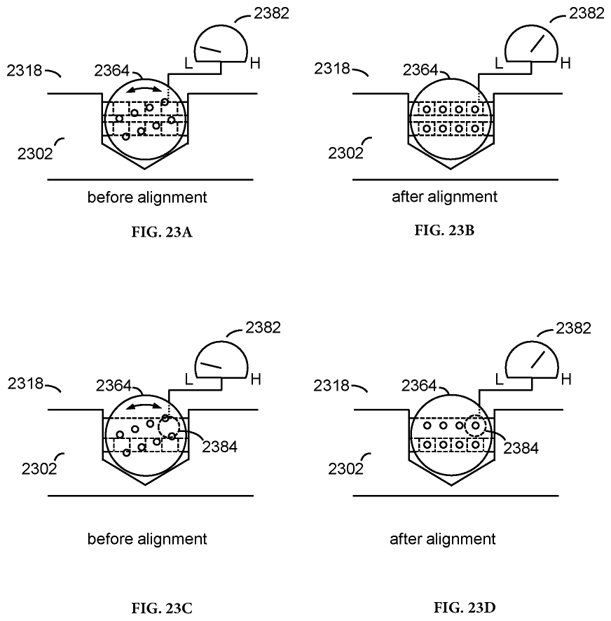

FIGS. 23A-23D show embodiments of methods of active alignment for aligning multiple cores of multicore fiber 2364 with the patterned planar waveguides of the fanout waveguide structure on the interposer PIC structure 2302. FIG. 23A shows an interposer PIC assembly 2318 for which the multicore fiber 2364 has multiple arrays of linearly configured cores in alignment with multiple waveguide layers on the interposer PIC structure. In an embodiment, a core in the upper array of cores or in the lower array of cores may be used to provide a pathway for active alignment as described herein. In other embodiments, the upper or lower arrays of cores may not be used in the PIC of the interposer PIC assembly and may be used for active alignment.

In an embodiment, an optical signal is provided to a core of the multicore fiber 2354. In a misaligned state, as shown in FIG. 23A, a weak or non-existent signal will be measured at the measurement apparatus 2382. As the multicore fiber 2364 is rotated (as shown by the arc with double arrows to indicate directions of rotation), the signal strength measured at the measurement apparatus will reach a maximum at the rotational orientation for which the core having the optical signal is in alignment with the patterned planar waveguide to which the measurement apparatus is coupled as shown in FIG. 23B. Multicore fibers 2364 may be secured in place with one or more of an epoxy, another adhesive material, and a mechanical means of holding the rotational alignment of the multicore fiber in alignment with the patterned planar waveguides of the fanout waveguide structure.

In another embodiment, an optical signal is provided from an emitting device to a patterned planar waveguide on the interposer PIC structure 2302 and subsequently from the patterned planar waveguide to a core of the multicore fiber 2364. In a misaligned state, as shown in FIG. 23A, a weak or non-existent signal will be measured at a measurement apparatus 2382 coupled to the core of the multicore fiber 2364 corresponding with the patterned planar waveguide that is carrying the optical signal from the emitting device. As the multicore fiber 2164 is rotated, the signal strength measured at the measurement apparatus will reach a maximum at a rotational orientation in which the core having the optical signal is in alignment with the patterned planar waveguide from which the optical signal from the emitting device is provided.

In some embodiments an unused or extra core present in the multicore fiber is used for active alignment of the cores of the multicore fiber 2364 and the patterned planar waveguides of the interposer PIC structure 2302, and the extra core is not in an array of cores that are aligned with a fanout waveguide.

In some embodiments, multicore fibers 2364 having more cores that the two arrays of linearly configured cores shown may be used.

FIG. 23C shows an embodiment in which a core of an upper array of cores of the multicore fiber is aligned with a collection area 2384. Collection area 2384 may be a receiving device or a portion of a receiving device for which the strength of an optical signal can be measured to assess the alignment of a core with the collection area. In other embodiments, a core in a lower array of linearly configured cores may be used. In other embodiments, another core in a linear array or not in a linear array of the multicore fiber may be used to actively align an array of linearly configured cores of a multicore fiber with the patterned planar waveguides of a fanout waveguide structure on an interposer PIC structure 2302. FIG. 23(d) shows the multicore fiber 2364 after the cores have been brought into alignment as described herein using measurement apparatus 2382.

In some embodiments, the extra core is a core that is not aligned with a terminal end of the patterned planar waveguide or spot size converter of a fanout waveguide.

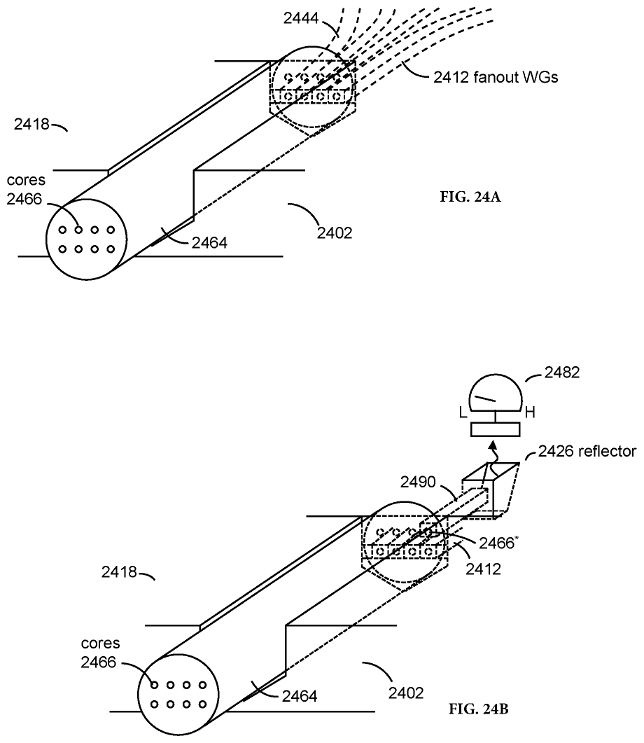

FIG. 24A shows a perspective drawing of an embodiment showing the fanout waveguide in alignment with a linear row of cores in a MCF.

FIG. 24B shows a perspective drawing of an embodiment showing the fanout waveguide in alignment with a linear row of cores in a MCF and a channel in another row used for alignment by coupling a signal from the MCF to a reflector and a surface mounted device.

FIG. 24A shows a perspective drawing of an embodiment of interposer PIC assembly 2418 having interposer PIC structure 2402 and multicore fiber 2464. A linearly configured array of cores 2466 of multicore fiber 2464 is shown in alignment with the patterned planar waveguides 2444 of fanout waveguide structure 2412.

FIG. 24B shows an embodiment of an interposer PIC assembly 2418 for which a core 2466* of the multicore fiber 2464, is shown in alignment with a waveguide 2490 that is coupled to reflector 2426. The reflector 2426 is coupled to measurement apparatus 2482 that can send or receive an optical signal to the reflector 2426.

The core 2466* used to actively align the linearly configured lower array of cores with the patterned planar waveguides of the fanout waveguide structure 2412 is shown coupled to an optional waveguide 2490 which in turn is connected to a reflector 2426. The use of reflector 2426 enables the measurement apparatus to be coupled to the core 2466* without the need to physically contact the measurement apparatus with the interposer PIC structure 2402. Non-contact and remote measurement methods are generally preferred over methods in which a physical contact must be made with a portion of the interposer PIC structure 2402.

The foregoing disclosure of embodiments of interposer PIC structures and assemblies comprising the interposer PIC structure, devices, and multicore fibers having linearly configured arrays of cores has been presented for purposes of illustration and description. The disclosure is not intended to be exhaustive or to limit the invention to the precise forms disclosed. Many of the drawings and the features provided in the figures are not drawn to scale but rather are drawn with the intention of improving and clarifying the descriptions and discourse provided herein. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising
preparing a substrate;
forming multiple waveguides on the substrate,
wherein the multiple waveguides comprise a fan-out configuration from a first end to a second end;
forming a device alignment feature on the substrate,
wherein the device alignment feature comprises one or more z alignments configured to align multiple optical or optoelectrical devices with the multiple waveguides at the second end in a direction perpendicular to the substrate;
forming a fiber alignment feature on the substrate;
forming a recess on the substrate for attaching a multicore fiber to the substrate,
wherein the fiber alignment feature is configured for aligning the multicore fiber in one or more directions parallel to the substrate with the multiple waveguides at the first end.

2. A method as in claim 1, further comprising
mounting the multiple optical or optoelectrical elements on the substrate,
wherein the multiple optical or optoelectrical elements are mounted on the one or more z alignments for automatically aligning with the multiple waveguides at the second end.

3. A method as in claim 1, further comprising
forming a cavity on the substrate,
wherein the cavity is configured to expose the one or more z alignments,
wherein the cavity is configured to house the multiple optical or optoelectrical devices.

4. A method as in claim 1,
wherein the device alignment feature further comprises one or more lateral alignment configured to restrict movements of the multiple optical or optoelectrical devices in the one or more directions parallel to the substrate.

5. A method as in claim 1, further comprising
simultaneously forming the device alignment feature and the fiber alignment feature on the substrate while forming the multiple waveguides,

6. A method as in claim 1, further comprising
simultaneously forming the device alignment feature, the fiber alignment feature, and a fiducial mark on the substrate while forming the multiple waveguides,
wherein the device alignment feature further comprises one or more lateral alignment configured to restrict movements of the multiple optical or optoelectrical devices in the one or more directions parallel to the substrate,
wherein the fiducial mark is configured for aligning the multiple optical or optoelectrical devices in the one or more directions parallel to the substrate with the multiple waveguides at the second end.

7. A method as in claim 1, further comprising
simultaneously forming device alignment features, fiducial marks, and a fiber align feature on the substrate while forming the multiple waveguides,
wherein the device alignment features and the fiducial marks are configured for aligning optical or optoelectrical devices with the multiple waveguides at the second end,
wherein the fiber alignment feature is configured for aligning the at least a multicore fiber with the multiple waveguides,
forming a layer covering the multiple waveguides, the device alignment features, the fiducial marks, and the fiber alignment feature,
forming multiple recesses for exposing at least the device alignment features, and the fiber alignment feature.

8. A method as in claim 1, further comprising
forming spot size converters for the multiple waveguides at the first end,
wherein the spot size converters are configured to improve the alignment of the multicore fiber with the multiple waveguides.

9. A method as in claim 1,
wherein preparing the substrate comprises
fabricating one or more electrical devices;
forming an interconnect layer on the one or more electrical devices,
wherein the interconnect layer comprises at least a first interconnect line configured to be connected to a terminal of an electrical device of the multiple electrical devices,
wherein the interconnect layer comprises at least a second interconnect line configured to be connected to a terminal of an optical or optoelectrical device of the multiple optical or optoelectrical device.

10. A method as in claim 1,
wherein the multicore fiber is disposed in a fiber attachment unit,
wherein the multicore fiber is pre-aligned in a rotational direction in the fiber attachment unit,
wherein the recess is configured for attaching the fiber attachment unit,
wherein the fiber alignment feature is configured for aligning the fiber attachment unit in the one or more directions parallel to the substrate.

11. A method as in claim 1,
wherein an end portion of the multicore fiber comprises a rotation alignment feature for rotational alignment of the multicore fiber with the waveguides,
wherein the recess comprises a mating feature configured to match the rotation alignment feature on the multicore fiber.

12. A method as in claim 1, further comprising
forming a rotation alignment element on the substrate,
wherein the rotation alignment element is configured to be coupled to a core of the multicore fiber,
wherein the rotation alignment element is configured to be coupled to a measurement apparatus to determine a strength of the coupling of the core with the rotation alignment element,
wherein the strength is configured to assess a rotation alignment of the multicore fiber to the multiple waveguides.

13. A method as in claim 1, further comprising
forming a reflector on the substrate,
wherein the reflector is configured to be coupled to a waveguide of the multiple waveguide with the waveguide coupled to a core of the multicore fiber,
wherein the reflector is configured to be coupled to a measurement apparatus to determine a strength of the coupling of the core with the waveguide,
wherein the strength is configured to assess a rotation alignment of the multicore fiber to the multiple waveguides.

14. A method as in claim 1, further comprising
forming second multiple waveguides on the substrate above the multiple waveguides,
wherein the second multiple waveguides comprise a fan-out configuration from the first end to the second end;
wherein the second multiple waveguides at the first end are configured to be aligned with one or more cores at a second row of the multicore fiber.

15. A method comprising
preparing a substrate;
depositing multiple layers on the substrate;
patterning the multiple layers to form multiple waveguides, a device alignment feature, and a fiber align feature,
wherein the device alignment feature comprises one or more z alignments configured to align multiple optical or optoelectrical devices with the multiple waveguides at the second end in a direction perpendicular to the substrate;
wherein the fiber alignment feature is configured for aligning a multicore fiber in one or more directions parallel to the substrate with the multiple waveguides at the first end.
wherein the multiple waveguides comprise a fan-out configuration from a first end to a second end;
forming a layer covering the multiple waveguides, the device alignment feature, and the fiber alignment feature;
forming multiple recesses on the substrate,
wherein a first recess of the multiple recesses is configured to expose the device alignment features and the multiple waveguides at the second end,
wherein the first recess is configured for accepting one or more optical or optoelectrical devices on the substrate and aligned with the multiple waveguides through the device alignment feature,
wherein a second recess of the multiple recesses is configured to expose the fiber alignment feature and the multiple waveguides at the first end,
wherein the second recess is configured for accepting the multicore fiber on the substrate and aligned with the multiple waveguides through the fiber alignment feature,
forming a groove in the second recess,
wherein the groove is configured for accepting a multicore fiber attached to the substrate,

16. A method as in claim 1, further comprising
wherein the patterning of the multiple layers further simultaneously forms a fiducial mark on the substrate,
wherein the fiducial mark is configured for aligning the multiple optical or optoelectrical devices in the one or more directions parallel to the substrate with the multiple waveguides at the second end.

17. A method as in claim 15,
wherein the multicore fiber is disposed in a fiber attachment unit,
wherein the multicore fiber is pre-aligned in a rotational direction in the fiber attachment unit,
wherein the recess is configured for attaching the fiber attachment unit,
wherein the fiber alignment feature is configured for aligning the fiber attachment unit in the one or more directions parallel to the substrate.

18. A method as in claim 15, further comprising
forming a reflector on the substrate,
wherein the reflector is configured to be coupled to a waveguide of the multiple waveguide with the waveguide coupled to a core of the multicore fiber,
wherein the reflector is configured to be coupled to a measurement apparatus to determine a strength of the coupling of the core with the waveguide,
wherein the strength is configured to assess a rotation alignment of the multicore fiber to the multiple waveguides.

19. An assembly comprising
a substrate;
multiple waveguides disposed on the substrate,
wherein the multiple waveguides comprise a fan-out configuration from a first end to a second end;
a device alignment feature on the substrate,
wherein the device alignment feature comprises one or more z alignments configured to align multiple optical or optoelectrical devices with the multiple waveguides at the second end in a direction perpendicular to the substrate;
a fiber alignment feature on the substrate;
a recess on the substrate for attaching a multicore fiber to the substrate,
wherein the fiber alignment feature is configured for aligning the multicore fiber in one or more directions parallel to the substrate with the multiple waveguides at the first end.
a reflector on the substrate,
wherein the reflector is configured to be coupled to a waveguide of the multiple waveguide with the waveguide coupled to a core of the multicore fiber,
wherein the reflector is configured to be coupled to a measurement apparatus to determine a strength of the coupling of the core with the waveguide,
wherein the strength is configured to assess a rotation alignment of the multicore fiber to the multiple waveguides.

20. An assembly as in claim 19, further comprising
second multiple waveguides on the substrate above the multiple waveguides,
wherein the second multiple waveguides comprise a fan-out configuration from the first end to the second end;
wherein the second multiple waveguides at the first end are configured to be aligned with one or more cores at a second row of the multicore fiber.
